(19) United States
(12) Patent Application Publication
(10) Pub. No.: US 2024/0213921 A1
(43) Pub. Date: Jun. 27, 2024

(54) SHADE DETECTION AND GLOBAL MAXIMUM POWER POINT TRACKING METHOD AND APPARATUS FOR EFFICIENT PHOTOVOLTAIC POWER CONVERSION

(71) Applicant: POSTECH Research and Business Development Foundation, Pohang-si (KR)

(72) Inventors: Young Jin KIM, Pohang-si (KR); Ji Hun HA, Pohang-si (KR); Ram Jothikumar PRASANTH, Pohang-si (KR)

(73) Assignee: POSTECH Research and Business Development Foundation, Pohang-si (KR)

(21) Appl. No.: 18/087,769

(22) Filed: Dec. 22, 2022

(30) Foreign Application Priority Data
Dec. 21, 2022 (KR) 10-2022-0180336

(51) Int. Cl. H02S 50/10; G05F 1/67

(52) U.S. Cl. CPC H02S 50/10; G05F 1/67

(57) ABSTRACT

Disclosed are a shade detection and global maximum power point tracking method and apparatus for photovoltaic power conversion. The method comprises: setting an array voltage at a first duty and an array current at a second duty among data sheet values of a PV array of a PV module as a reference array voltage and a reference array current, respectively; calculating a MPP resistance of the PV array based thereon; calculating a duty to be applied to a switch of a boost converter of the PV module based on the MPP resistance; obtaining an actual array voltage and an actual array current of the PV array based on the duty; and determining whether a uniform shade case occurs based on the actual array voltage, the actual array current, and actual power.

### CROSS-REFERENCE TO RELATED APPLICATIONS

This application claims priority to Korean Patent Application No. 2022-0180336 filed on Dec. 21, 2022 in the Korean Intellectual Property Office (KIPO), the entire contents of which are hereby incorporated by reference.

### BACKGROUND

### 1. Technical Field

Example embodiments of the present invention relate to a shade detection and global maximum power point (GMPP) tracking method and an apparatus for photovoltaic power conversion, which allow a photovoltaic (PV) system to always operate at a GMPP through a simplified shade detection method.

### 2. Related Art

One of the goals of recent global research is to achieve a clean and resilient power system through accelerated renewable energy sources with the aim of net zero carbon emissions. Under these circumstances, a photovoltaic (PV) system is highly prioritized as a renewable energy resource with numerous advantages. However, due to output variability of the PV system, a connection with a power electronics interface is required. The use of a power electronics interface helps to obtain maximum power point tracking (MPPT) in the PV system.

The MPPT in the PV system is used to process partial shade (PS) in a PV array which is subjected to non-uniform irradiation due to buildings, pillars, and dust. That is, when the PS occurs, a power-voltage (P-V) characteristic curve with multiple power peaks and a current-voltage (I-V) characteristic curve with multiple steps are generated so that the MPPT of the PV system becomes complicated.

In other words, all of the existing representative methods, such as a perturb and observe (P&O) algorithm, an incremental conductance (INC) algorithm, and a hill climbing (HC) algorithm, do not consider the distinction between a local maximum power point (LMPP) and a global maximum power point (GMPP) so that it is very difficult for the these methods to find a GMPP in PS.

Meanwhile, in order to solve the above problem, several optimization algorithms, such as particle swarm optimization (PSO), a flower pollination algorithm (FPA), a hybrid Jaya-differential evaluation algorithm (HJDEA), gray wolf optimization (GWO), and a monkey king optimizer (MKO), have been suggested. These conventional optimization algorithms help to find the GMPP during PS. However, all the existing algorithms and optimization algorithms have limitations such as high transient switching at an initial step, a tendency to get trapped in an LMPP, a lack of randomness of control variables, and inability to distinguish between uniform shade and PS.

In addition to the above-described optimization algorithms, hybrid methods and model-based methods in which the existing algorithms are combined with the optimization methods have been proposed. However, the proposed existing methods also have limitations in effective performance improvement for a shade detection process due to high computational complexity related to shade detection or due to parameter tuning problems.

### SUMMARY

Example embodiments of the present invention provide a shade detection and global maximum power point (GMPP) tracking method, which allows a photovoltaic (PV) system to always operate at a GMPP through a simplified shade detection method.

Example embodiments of the present invention also provide a shade detection and GMPP tracking method and an apparatus, which effectively identify shade occurrence in the PV system.

According to a first exemplary embodiment of the present disclosure, a shade detection and global maximum power point (GMPP) tracking method, which is performed by a processor, may comprise: setting an array voltage at a 0.1 duty and an array current at a 0.9 duty among data sheet values of a photovoltaic (PV) array of a PV module as a reference array voltage and a reference array current, respectively; calculating a maximum power point (MPP) resistance of the PV array on the basis of the reference array voltage and the reference array current; calculating a duty to be applied to a switch of a boost converter of the PV module on the basis of the MPP resistance; obtaining an actual array voltage and an actual array current of the PV array on the basis of the duty; and determining whether a uniform shade case occurs on the basis of the actual array voltage, the actual array current, and actual power obtained from the actual array voltage and the actual array current, wherein, the determining of whether the uniform shade case occurs includes determining whether the actual array current is greater than or equal to 0.9 times the reference array current.

The shade detection and GMPP tracking method may further comprise, after the determining of whether the uniform shade case occurs, detecting a shade level for severity of a current shade case, wherein the shade level includes a global power peak case which is a relatively less complex shade case, and a partial shade case which is a relatively more complex shade case.

The shade detection and GMPP tracking method may further comprise determining that the global power peak case occurs when a change of a preset reference value or more in each of the actual array voltage and the actual array current occurs on the basis of the duty.

The shade detection and GMPP tracking method may further comprise determining that the partial shade case occurs when each of the actual array voltage and the actual array current does not satisfy the preset reference value.

The shade detection and GMPP tracking method of may further comprise searching for a GMPP when it is determined that the partial shade case occurs, wherein the searching for the GMPP uses a relatively large step size first and then uses a relatively small step size when changing the duty in MPP tracking.

The searching for the GMPP in the PS case may include: performing a search by continuously using the large step size when a current difference between actual array currents according to a change in duty is 10% or less of the reference array current; and changing to a preset small step size and performing a search again when the current difference exceeds 10% of the reference array current.

The shade detection and GMPP tracking method may further comprise setting the duty to be closest to the MPP located on a voltage-current curve when the current shade case is the uniform shade case.

The shade detection and GMPP tracking method may further comprise, after the determining of whether the uniform shade case occurs, detecting a shade level for severity of the current shade case, wherein the detecting of the shade level includes determining that the current shade case is the uniform shade case when the actual array voltage exceeds 80% of the PV array voltage.

The shade detection and GMPP tracking method may further comprise searching for a GMPP using the MPP resistance.

The shade detection and GMPP tracking method may further comprise: setting a step size of the duty to a predetermined value in the searching for the GMPP; and declaring a step size that is greater than the predetermined value in order to find a current difference.

The shade detection and GMPP tracking method may further comprise, after the declaring of the step size, diagnosing the current difference using a duty of first peak power as a reference duty.

The diagnosing of the current difference may include determining whether the actual array voltage exceeds a limit of the PV array voltage.

The shade detection and GMPP tracking method may further comprise performing a GMPP search for at least one of a right hand side (RHS) and a left hand side (LHS) of a reference MPP load line when the actual array voltage exceeds the limit of the PV array voltage.

According to a second exemplary embodiment of the present disclosure, a shade detection and global maximum power point (GMPP) tracking apparatus may comprise: a processor configured to execute at least one program command stored in a memory or a storage, wherein, in response to the at least one program command, the processor performs: setting an array voltage at a 0.1 duty and an array current at a 0.9 duty among data sheet values of a photovoltaic (PV) array of a PV module as a reference array voltage and a reference array current, respectively; calculating a maximum power point (MPP) resistance of the PV array on the basis of the reference array voltage and the reference array current; calculating a duty to be applied to a switch of a boost converter of the PV module on the basis of the MPP resistance; obtaining an actual array voltage and an actual array current of the PV array on the basis of the duty; and determining whether a uniform shade case occurs on the basis of the actual array voltage, the actual array current, and actual power obtained from the actual array voltage and the actual array current, wherein in the determining of whether the uniform shade case occurs, the processor determines whether an intensity of the actual array current is greater than or equal to 0.9 times an intensity of the reference array current.

The processor may receive a PV array current from a current sensor configured to detect a current flowing through a positive terminal of two terminals of a boost converter connected to the PV array; receive a PV array voltage from a voltage sensor configured to detect a voltage between both ends of a first capacitor connected parallel to the two terminals of the boost converter connected to the PV array; and control operation of a switch for MPP tracking in the boost converter on the basis of the PV array current and the PV array voltage.

After the determining of whether the uniform shade case occurs, the processor may further perform detecting a shade level for severity of the current shade case, wherein the shade level includes a global power peak case which is a relatively less complex shade case, and a partial shade case which is a relatively more complex shade case.

The processor may further perform determining that the global power peak case occurs when a change of a preset reference value or more in each of the actual array voltage and the actual array current occurs on the basis of the duty.

The processor may further perform determining that the partial shade case occurs when each of the actual array voltage and the actual array current does not satisfy the preset reference value.

The processor may further perform searching for a GMPP when it is determined that the partial shade case occurs; and in the searching for the GMPP, the processor may use a relatively large step size first and then use a relatively small step size when changing the duty value in MPP tracking.

In the searching for the GMPP, the processor may perform a search by continuously using the large step size when a current difference between actual array currents according to a change in duty is 10% or less of the reference array current, and change to a preset small step size and perform a search again when the current difference exceeds 10% of the reference array current.

According to the above-described present invention, there is provided a PV control method with excellent ability capable of accurately distinguishing uniform shade due to uniform irradiation, relatively less complex shade, and relatively more complex shade in the PV system, and an apparatus using the same.

In addition, according to the present invention, in a uniform case due to uniform irradiation or a relatively less complex shade case, an MPP is estimated, and an MPP tracking algorithm such as a simplified perturb and observe (P&O) algorithm is triggered so that fast convergence from three initially input samples to the MPP can be achieved.

In addition, according to the present invention, in a relatively more complex shade, a global MPP (GMPP) can be effectively found using an MPP tracking algorithm (exploitation of the existing P&O algorithm is possible) which uses two different step sizes, and by using the GMPP, it can contribute to efficient operation of the PV system even in a very complex shade region.

Furthermore, in order to find the GMPP, by setting and using a reference duty ratio, even in a relatively more complex shade case, the GMPP can be effectively found using an MPP tracking algorithm such as the existing P&O algorithm.

### BRIEF DESCRIPTION OF DRAWINGS

FIGS. 1A to 1D are graphs showing current-voltage (I-V) characteristic curves and power-voltage (P-V) characteristic curves with respect to uniform shade patterns and partial shade (PS) patterns for describing an MPP operation of the PV array.

FIG. 2 is a schematic diagram illustrating a PV system with a DC-DC interface.

FIG. 3A is a graph for describing a load line analysis process of uniform and GPP cases.

FIG. 3B is a graph for describing the voltage and current limits of the GPP case.

FIG. 3C is a graph for describing a load line analysis process of a relatively less complex shade profile.

FIG. 3D is a graph for describing the voltage and current limits of a relatively more complex shade profile.

FIG. 4A is a graph showing voltage and current convergence characteristics of Shade Pattern 1 which is a uniform shade pattern.

FIG. 4B is a graph showing voltage and current convergence characteristics of Shade Pattern 5 which is a PS pattern.

FIG. 4C is a graph showing voltage and current convergence characteristics of Shade Pattern 6 which is another PS pattern.

FIG. 5A is a graph showing load line analysis results of Shade Pattern 1 and Shade Pattern 7.

FIG. 5B is a graph for describing reference load line estimation of Shade Pattern 7.

FIG. 5C is a graph for describing power peak estimation using a reference duty value in a right hand side (RHS) of a GMPP search.

FIG. 5D is a graph for describing power peak estimation using a reference duty value in a left hand side (LHS) of the GMPP search.

FIG. 6A is a graph for describing the GMPP tracking on Shade Pattern 7.

FIG. 6B is a graph for describing a principle of RHS-based tracking which may be performed to solve a misconception about the current difference in Shade Pattern 7.

FIG. 7 is a graph for describing voltage and current convergence characteristics for Shade Pattern 7.

FIGS. 8A to 8D are flowcharts illustrating a novel shade detection and GMPP tracking method for efficient photovoltaic power conversion, that is, briefly referred to as a “detection and tracking method,” according to one embodiment of the present invention.

FIGS. 9A to 9I are graphs showing simulation verification results of Shade Patterns 1 to 9.

FIG. 10 is a schematic block diagram illustrating a novel shade detection and GMPP tracking apparatus (hereinafter briefly referred to as a “detection and tracking apparatus”) for efficient photovoltaic power conversion according to another embodiment of the present invention.

FIGS. 11A to 11I are graphs showing results according to hardware implementation of Shade Patterns 1 to 9, respectively.

FIG. 12A is a graph showing the results of applying the detection and tracking method of the present embodiment to the PV system.

FIG. 12B is a graph showing the results of applying the PSO method of the comparative example to the PV system.

FIG. 12C is a graph showing the results of applying the hybrid RAT algorithm of another comparative example to the PV system.

### DESCRIPTION OF EXAMPLE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Prior to a detailed description of a new shade detection and global maximum power point (GMPP) tracking method for efficient photovoltaic power conversion (hereinafter simply referred to as a “detection and tracking method′) of the present embodiment, an MPP operation of a photovoltaic (PV) array will be described.

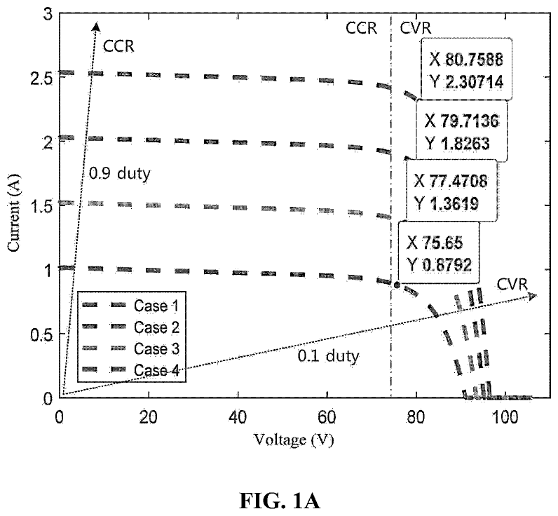

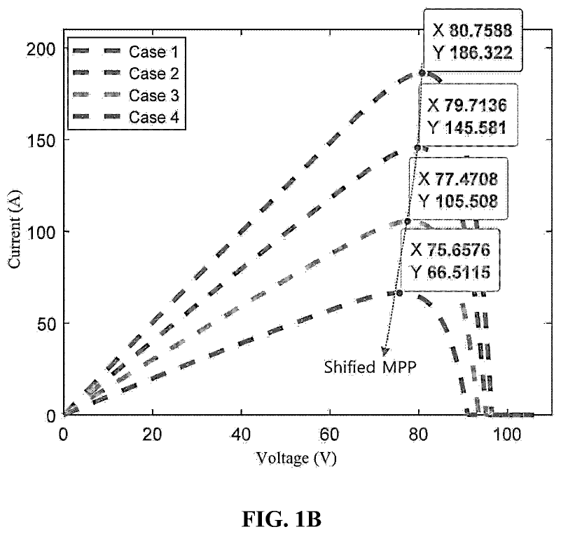

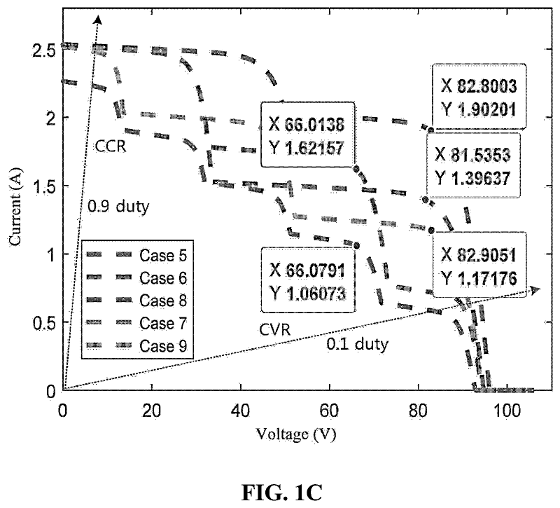

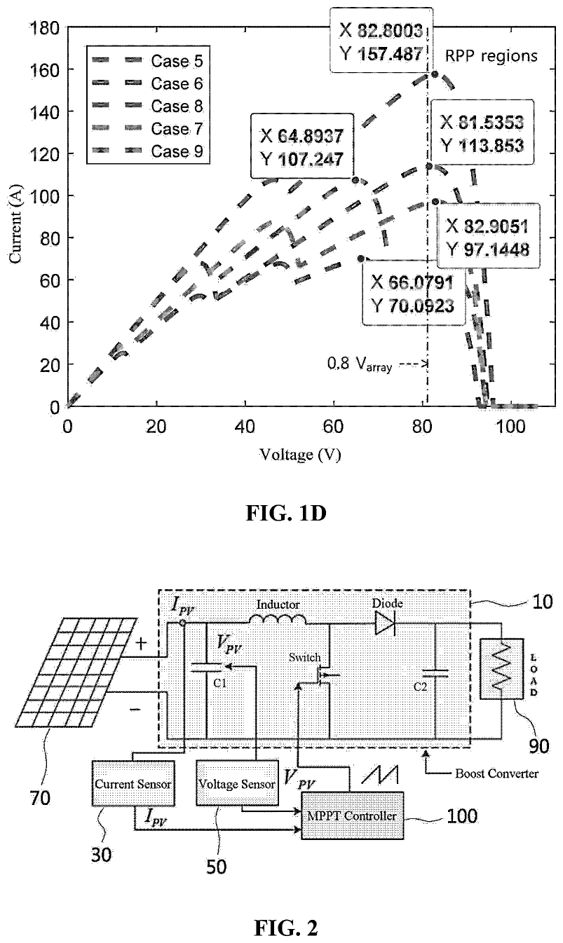

FIGS. 1A to 1D are graphs showing current-voltage (I-V) characteristic curves and power-voltage (P-V) characteristic curves with respect to uniform shade patterns and partial shade (PS) patterns for describing an MPP operation of the PV array.

The MPP operation of the PV array requires an understanding of the I-V characteristic curves and the P-V characteristic curves during uniform shade and PS. For convenience of understanding, an example of simulation results for nine shade profiles will be described.

TABLE 1

| Shade pattern | Row 1 | Row 2 | Row 3 | Row 4 | Row 5 |
|---|---|---|---|---|---|
| Pattern 1 | 1000 | 1000 | 1000 | 1000 | 1000 |
| Pattern 2 | 800 | 800 | 800 | 800 | 800 |
| Pattern 3 | 600 | 600 | 600 | 600 | 600 |
| Pattern 4 | 400 | 400 | 400 | 400 | 400 |
| Pattern 5 | 1000 | 1000 | 1000 | 800 | 800 |
| Pattern 6 | 1000 | 1000 | 600 | 600 | 600 |
| Pattern 7 | 1000 | 800 | 800 | 500 | 500 |
| Pattern 8 | 900 | 750 | 600 | 450 | 250 |
| Pattern 9 | 1000 | 1000 | 700 | 700 | 300 |

As shown in Table 1, in order to simulate nine different shade profiles, programming was performed in a block diagram environment for simulation and design in consideration of data of a predetermined PV panel. Simulink for multi-domain simulation and model-based design may be used as the block diagram environment.

Simulink may support system-level design, simulation, automatic code generation, continuous testing and validation of an embedded system and provide a graphical editor, a customizable block library, and a solver for dynamic system modeling and simulation. Simulink may also be integrated with MATLAB, which is a kind of software providing a numerical analysis and programming environment, to integrate a MATLAB algorithm into a model and export a simulation result to MATLAB for further analysis. In the following description, the above-described Simulink will be briefly referred to as MATLAB/SIMULINK.

The shade profiles are divided four uniform shade cases indicated as Case 1 to Case 4 and five PS cases indicated as Case 5 to Case 9.

I-V characteristic curves related to the uniform shade cases are shown in FIG. 1A, and P-V characteristic curves related to the uniform shade cases are shown in FIG. 1B. In addition, I-V characteristic curves related to the PS cases are shown in FIG. 1C and P-V characteristic curves related to the PS cases are shown in FIG. 1D.

For shade distinction, GMPP data values are shown in each drawing.

The uniform shade patterns have relatively less complex I-V characteristics in two regions shown in FIG. 1A, that is, constant voltage regions (CVR) and constant current regions (CCR).

In addition, as shown in FIG. 1B, in the uniform shade patterns, it was observed that, when irradiation decreased from 1000 W/m² to 400 W/m², an MPP and an open circuit voltage V_{OC} were gradually shifted to the left. In addition, the well-known relationship between an MPP voltage V_{MPP}, an MPP current I_{MPP}, the open circuit voltage V_{OC}, and a short-circuit current I_{SC}, that is, V_{MPP}=0.8V_{OC} and I_{MPP}=0.9I_{SC}, was found to be true by the present inventors.

In FIG. 1A, a GMPP of Case 1 is shown as (80.7588, 2.30714), a GMPP of Case 2 is shown as (79.7136, 1.8263), a GMPP of Case 3 is shown as (77.4708, 1.3619), and a GMPP of Case 4 is shown as (75.65, 0.8792). Similarly, in FIG. 1B, a GMPP of Case 1 is shown as (80.7588, 186.322), a GMPP of Case 2 is shown as (79.7136, 145.581), a GMPP of Case 3 is shown as (77.4708, 105.508), and a GMPP of Case 4 is shown as (75.6576, 66.5115).

As shown in FIG. 1C, the PS patterns exhibit high shade vulnerability in Cases 8 and 9, whereas, in Cases 5 to 7, GMPPs are at right power peaks (RPPs) so that complexity is relatively small. Therefore, in the following embodiments, a less complex shade pattern in which a GMPP is present in an RPP region is referred to as a global power peak (GPP) case, and a very complex shade pattern with a P-V characteristic is referred to as a PS case.

In FIG. 1C, a GMPP of Case 5 is shown as (82.8003, 1.90201), a GMPP of Case 6 is shown as (81.5353, 1.39637), a GMPP of Case 7 is shown as (82.9051, 1.17176), a GMPP of Case 8 is shown as (66.0791, 1.06073), and a GMPP of Case 9 is shown as (66.0138, 1.62157). Similarly, in FIG. 1D, a GMPP of Case 5 is shown as (82.8003, 157.487), a GMPP of Case 6 is shown as (81.5353, 113.853), a GMPP of Case 7 is shown as (82.9051, 97.1448), a GMPP of Case 8 is shown as (66.0791, 70.0923), and a GMPP of Case 9 is shown as (64.8937, 107.247).

FIG. 2 is a schematic diagram illustrating a PV system with a DC-DC interface.

Referring to FIG. 2, the PV system may include a controller 100 connected to a boost converter 10, a current sensor 30, and a voltage sensor 50. The controller 100 may be referred to as a controller for maximum power point tracking (MPP), that is, an MPPT controller. The controller 100 may include a processor and a memory.

The boost converter 10 may have a configuration including an inductor, a diode, a switch, a first capacitor C1, and a second capacitor C2. One end of the boost converter 10 may be connected to a PV array 70, and the other end thereof may be connected to a load 90.

A first terminal of the inductor may be commonly connected to a first terminal of the first capacitor C1 and a positive terminal of two terminals of the boost converter 10 connected to the PV array 70, and a second terminal of the inductor may be commonly connected to a first terminal of the diode and a first terminal of the switch. In addition, a second terminal of the diode may be commonly connected to a first terminal of the second capacitor C2 and a first terminal of the load 90. A negative terminal of the two terminals of the boost converter 10 connected to the PV array 70 and a second terminal of the load 90 may be commonly connected to a second terminal of the first capacitor C1, a second terminal of the switch, and a second terminal of the second capacitor C2.

The above-described configuration of the boost converter 10 is not limited to the configuration exemplified in the present embodiment, and any other alternative one among configurations of various boost converters already well known in the art may be selected and used.

The current sensor 30 may detect a PV array current I_{PV} flowing through the positive terminal of the two terminals of the boost converter 10 connected to the PV array 70 and transfer the detected PV array current I_{PV} to the controller 100.

The voltage sensor 50 may detect a voltage between both ends of the first capacitor C1 connected parallel to the two terminals of the boost converter 10 connected to the PV array 70 and transfer a PV array voltage V_{PV} corresponding to the detected voltage to the controller 100.

The controller 100 may control the operation of the switch on the basis of the PV array current I_{PV} and the PV array voltage V_{PV}. The controller 100 may be connected to a control terminal of the switch and may control the operation of the switch using a control signal in the predetermined form of a sawtooth wave or a square wave.

The above-described PV system may be modeled using MATLAB/SIMULINK to perform shade detection. Regarding converter switching of the MPPT controller 100 implemented as a DC-DC boost converter in the present embodiment, parameters may be set such that a switching frequency fₛ of the switch is 10 kHz, an inductance L of the inductor is 1 mH, a resistance R_{L} of the load 90 is 200Ω, and a capacitance of the second capacitor C2 is 100 μF (650 V basis). The shade detection-based GMPP tracking algorithm according to the present embodiment may be programmed into the boost converter 10. For evaluation, a case in which a duty value D of the switch is 0.1 may be set as a CVR, and a case in which the duty value D thereof is 0.9 may be set as a CCR.

### Shade Detection in Uniform Case and GPP Case

Shade detection is essential in PV systems to distinguish uniform irradiation, i.e., a uniform shade condition and a PS condition, to accurately determine a position of an MPP, and to improve tracking and power conversion efficiency. In the present embodiment, the shade detection is performed on the basis of two samples of a CVR (D=0.1) and a CCR (D=0.9).

To this end, a PV array voltage V_{array} (at D=0.1) and a PV array current I_{array} (at D=0.9) are first obtained from the two samples. This is shown in the form of mathematical expressions as in the following Equation 1 and Equation 2.

$$Array Voltage , V at 0.1 duty = {V}_{array} \qquad [ Equation 1 ]$$

$$Array Current , I at 0.9 duty = {I}_{a r r a y} \qquad [ Equation 2 ]$$

As shown in Equation 1 and Equation 2, the detection and tracking method of the present embodiment, among electrical data on the PV array acquired from the PV panel, a specific array voltage V_{array} may be obtained from an array voltage V at a 0.1 duty, and a specific array current I_{array} may be obtained from an array current I at a 0.9 duty. In the following description, the specific array voltage V_{array} is referred to as a reference array voltage, and the specific array current I_{array} is referred to as a reference array current.

Next, resistance R_{MPP} is predicted at an MPP with respect to the uniform shade case on the basis of reference data on a previous sample, that is, V_{array} and I_{array}. This resistance R_{MPP} is a predicted resistance and may correspond to the resistance of the DC-DC boost converter itself. Mathematical expressions for the resistance R_{MPP} of the DC-DC boost converter and an estimated duty value D_{MPP} at the resistance R_{MPP} are as Equation 3 and Equation 4. The estimated duty value may be briefly referred to as a duty or a duty value.

$$Predicted resistance at MPP , {R}_{MPP} = \frac{{V}_{array}}{{I}_{array}} \qquad [ Equation 3 ]$$

$$Duty estmation at MPP , {D}_{MPP} = 1 - \sqrt{\frac{{R}_{MPP}}{{R}_{L}}} \qquad [ Equation 4 ]$$

As shown in Equation 3, the resistance R_{MPP} at the MPP corresponds to a value obtained by dividing an array voltage at a specific duty (hereinafter referred to as a first duty) by an array current at a specific duty (hereinafter referred to as a second duty). In addition, as shown in Equation 4, the estimated duty D_{MPP} at the MPP corresponds to a value obtained by subtracting a square root of a value, which is obtained by dividing the resistance R_{MPP} at the MPP by load resistance R_{L}, from 1.

Next, an actual array voltage and an actual array current are obtained at the MPP by applying the above-described resistance R_{MPP} at the MPP to an actual PV array, and uniform shade, global power peak shade, and PS may be searched for on the basis of the actual array voltage and the actual array current.

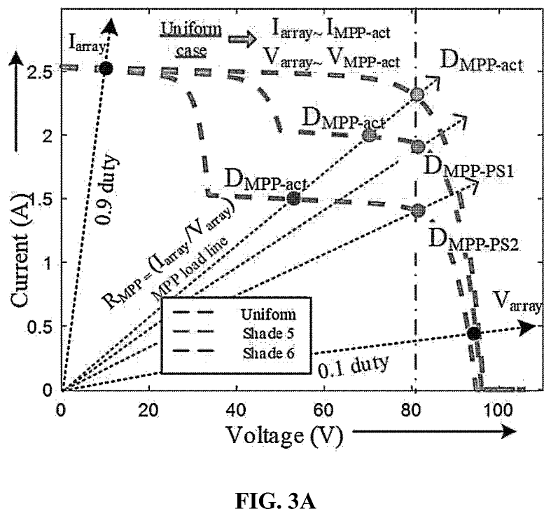

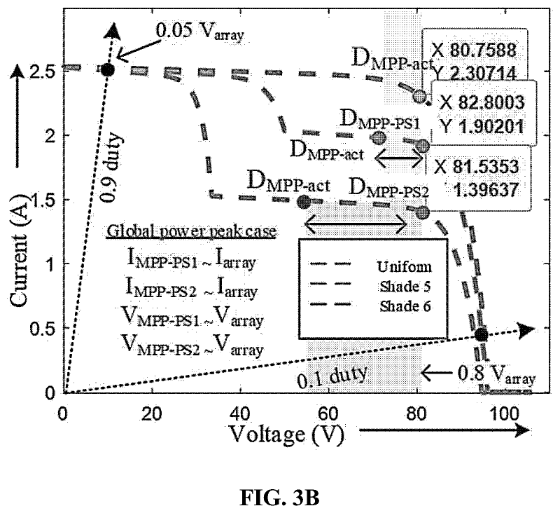

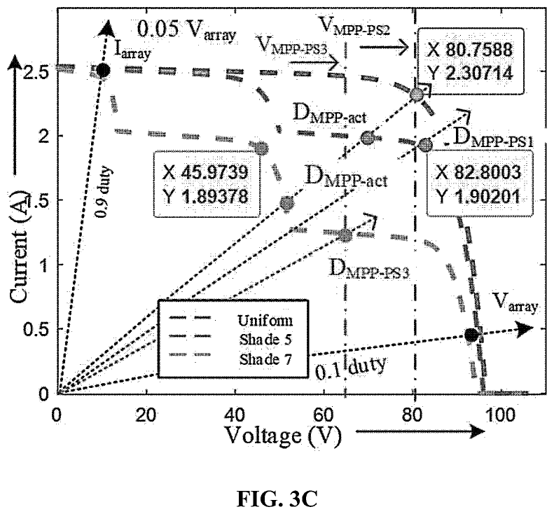

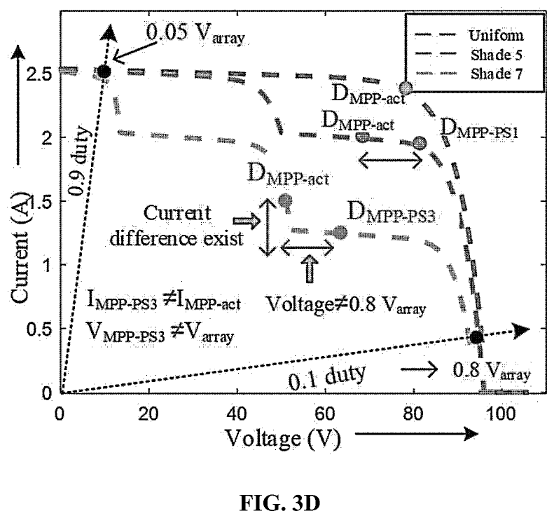

FIG. 3A is a graph for describing a load line analysis process of uniform and GPP cases. FIG. 3B is a graph for describing the voltage and current limits of the GPP case. FIG. 3C is a graph for describing a load line analysis process of a relatively less complex shade profile. In addition, FIG. 3D is a graph for describing the voltage and current limits of a relatively more complex shade profile.

For more effective shade distinction, I-V characteristic curves of Case 1 which is a uniform shade case and Cases 5 to 7 which are GPP cases may be considered. Case 1 may be indicated as Uniform, Case 5 may be indicated as Shade 5, Case 6 may be indicated as Shade 6, and Case 7 may be indicated as Shade 7. In FIG. 3A, based on a voltage of 80 V or an MPP load line, an actual duty value of Case 1 is greater than an actual duty value of Case 5, and the actual duty value of Case 5 is greater than an actual duty value of Case 6.

As shown in FIG. 3A, based on the MPP load line formed by an actual duty value D_{MPP-act} of each case at the MPP, in the case of a uniform case in which the shade of Case 1 is uniform, it can be confirmed that a voltage-current at the actual duty value D_{MPP-act}, that is, the actual array voltage is similar to the array voltage V_{array}, and the actual array current is similar to the array current I_{array} so that a GMPP condition is satisfied.

Hereinafter, the array voltage V_{array} at the first duty may be referred to as the reference array voltage V_{array}, and the array current I_{array} at the second duty may be referred to as the reference array current I_{array}.

Meanwhile, unlike the uniform shade of Case 1, in each of Cases 5 and 6, it can be confirmed that the actual array voltage, which is a voltage-current at the actual duty value D_{MPP-act}, differs from the reference array voltage V_{array} by a predetermined intensity or more, and the actual array current differs from the reference array current I_{array} by a predetermined intensity or more so that the GMPP condition is not satisfied.

In consideration of the above-described GMPP condition, mathematical expressions for determining whether corresponding irradiation is a uniform shade case for irradiation at a specific point of time on the PV array may be defined as the following Equation 5 and Equation 6.

$${V}_{MPP - act} \geq 0.8 {V}_{array} \qquad [ Equation 5 ]$$

$${I}_{MPP - act} \geq 0.9 {I}_{a r r a y} \qquad [ Equation 6 ]$$

Equation 5 and Equation 6 reflect significant test results on a relationship between the actual array voltage and the reference array voltage and a relationship between the actual array current and the reference array current.

The detection and tracking method according to the present embodiment may diagnose whether the current shade is the uniform shade case using an actual data set (D_{MPP-act}, V_{MPP-act}, I_{MPP-act}) at the estimated duty value and Equation 5 and Equation 6.

When the current shade is diagnosed as the uniform shade case, the detection and tracking method may specify or declare a duty as D_{MPP-act}. In addition, the detection and tracking method may maintain a current operating state to allow the PV panel to operate in an MPP tracking mode using an MPP tracking algorithm. Here, a P&O algorithm may be used as the MPP tracking algorithm.

In addition, the MPP tracking method of the present embodiment may declare the duty closer to the MPP load line. In this case, as the duty is declared closer to an MPP region, faster convergence may be obtained. As described above, in the case of the uniform shade, the MPP tracking method of the present embodiment may quickly identify an MPP position within three samples.

Meanwhile, in the case of a shade case not satisfying Equation 5 and Equation 6, the MPP tracking method may proceed to the next step for searching for a GPP case or a PS case. In the case of the GPP case, an RPP region may be searched for first.

In order to identify the GPP case located in the RPP region, resistance R_{MPP-PS} and a duty value D_{MPP-PS} may be predicted at an RPP using Equation 7 and Equation 8. Hereinafter, the resistance R_{MPP-PS} at the RPP may be referred to as NU resistance as resistance of a non-uniform shade case, and the duty value D_{MPP-PS} may be referred to as a NU duty.

$$Resistance at RPP , {R}_{MPP - PS} = \frac{{V}_{array}}{{I}_{MPP - act}} \qquad [ Equation 7 ]$$

$$Duty estimation at RPP , {D}_{MPP - PS} = 1 - \sqrt{\frac{{R}_{MPP - PS}}{{R}_{L}}} \qquad [ Equation 8 ]$$

As shown in Equation 7, the resistance R_{MPP-PS} at the RPP may correspond to a value obtained by dividing the reference array voltage V_{array} by the actual array current I_{MPP-act}, and the duty D_{MPP-PS} estimated at the RPP may correspond to a value obtained by calculating the square root of a value obtained by dividing the resistance R_{MPP-PS} at the RPP by the load resistance R_{L} and then by subtracting the square root value from 1.

In addition, as shown in FIG. 3A, when the MPP load line is used as a reference load line, significant changes occur in the voltage or current due to Equation 7 and Equation 8 on the basis of the actual duty values in Cases 5 and 6 (see FIG. 3B). Using the above description, it is possible to check shade occurrence of the GPP case only with the third sample.

In addition, in Cases 5 and 6, the actual data values V_{MPP-act} and I_{MPP-act} appear to violate Equation 5 and Equation 6 which are limits of uniform shade events. That is, the duty values of the GPP case for measuring the severity of the shade case may be estimated using Equation 7 and Equation 8. As shown in FIG. 3B, the estimated results may be indicated as a first NU duty D_{MPP-PS1} and a second NU duty D_{MPP-PS2}.

The voltage and current limits of the data set (V_{MPP-PS}, I_{MPP-PS}) of the duty D_{MPP}-PS at the RPP may be verified on the basis of the existing data or test results. That is, the voltage and the current limits of the data set (V_{MPP-PS}, I_{MPP-PS}) of the duty D_{MPP-PS} at the RPP may be expressed as Equation 9 and Equation 10.

$${V}_{MPP - PS} \geq 0.8 {V}_{array} \qquad [ Equation 9 ]$$

$${I}_{MPP - PS} \geq 0.9 {I}_{MPP - act} \qquad [ Equation 10 ]$$

According to Equation 9, in the case of GPP shade, the array voltage V_{MPP-PS} at the RPP obtained using the duty D_{MPP-PS} at the RPP should be greater than or equal to 0.8 times the reference array voltage V_{array}. In addition, according to Equation 10, in the case of the GPP shade, the array current I_{MPP-PS} at the RPP obtained using the duty D_{MPP-PS} at the RPP should be greater than or equal to 0.9 times the actual array current I_{MPP-act}.

In FIG. 3B, a GMPP of Case 1 is shown as (80.7588, 2.30714), a GMPP of Case 5 is shown as (82.8003, 1.90201), and a GMPP of Case 6 is shown as (81.5353, 1.39637).

As described above, the detection and tracking method according to the present embodiment may search for the GPP case, which is a less complex shade case, using the load line values of Cases 5 and 6 and Equation 9 and Equation 10.

Meanwhile, since cross-validation with the PS partial shade case, which is a very complex shade pattern, is required, FIGS. 3C and 3D are diagrams illustrating a concept of a load line shift using a uniform shade pattern, a relatively less complex shade pattern, and a relatively more complex shade pattern.

In FIGS. 3C and 3D, the uniform shade pattern may be indicated as “Uniform” as Case 1, the relatively less complex shade pattern may be indicated as “Shade 5” as Case 5, and the relatively more complex shade pattern may be indicated as “Shade 7” as Case 7. In addition, the relatively less complex shade pattern may be referred to as a less complex shade pattern, and the relatively more complex shade pattern may be referred to as a more complex shade pattern or a very complex shade pattern.

Referring to FIGS. 3C and 3D, unlike Case 5 which is the GPP case with the less complex shade pattern, in Case 7 which is a PS case with the more complex shade pattern, a significant current change and a relatively low voltage change can be seen when moving along the load line from the actual duty value D_{MPP-act} to a duty value D_{MPP-PS3} at the RPP. In FIGS. 3C and 3D, Case 1 has the largest current value and Case 7 has the smallest current value based on a voltage of 60 V or 80 V.

That is, since Case 5 satisfies Equation 9 and Equation 10, but Case 7 with the more complex shade pattern does not satisfy Equation 9 and Equation 10, Case 7 is detected as the more complex shade pattern through the shade detection, and thus an additional process of finding a GMPP is required.

In order to verify the above-described algorithm for finding the uniform shade and the GPP shade, a verification operation may be performed on a computer using a tool such as MATLAB/SIMULINK or like. A computer specification may use a configuration of 32 GB random access memory (RAM) and an Intel i7 processor, but the present invention is not limited thereto.

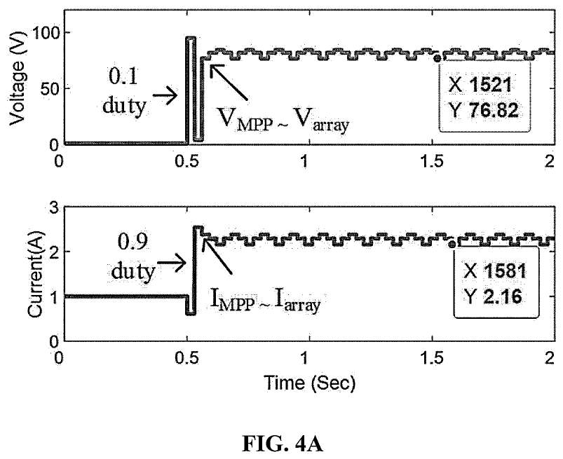

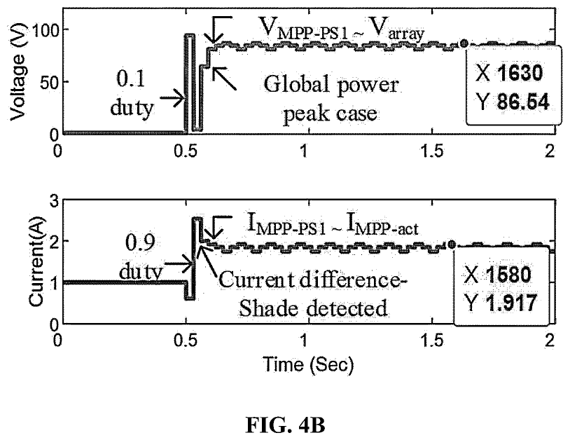

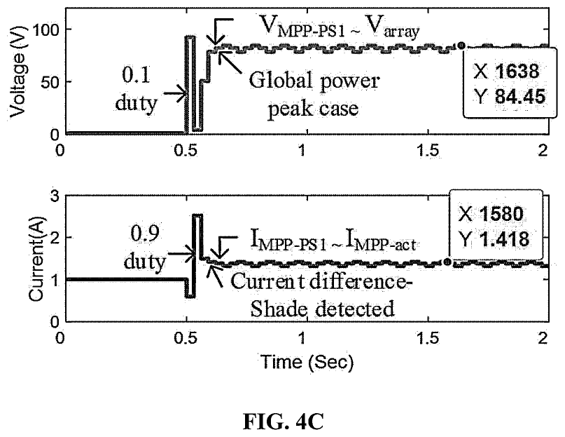

FIG. 4A is a graph showing voltage and current convergence characteristics of Shade Pattern 1 which is a uniform shade pattern. FIG. 4B is a graph showing voltage and current convergence characteristics of Shade Pattern 5 which is a PS pattern. In addition, FIG. 4C is a graph showing voltage and current convergence characteristics of Shade Pattern 6 which is another PS pattern.

The voltage and current convergence characteristics shown in FIGS. 4A to 4C are shown for Shade Pattern 1, Shade Pattern 5, and Shade Pattern 6, respectively. For shade detection of a voltage in each case, a sample with a 0.1 duty may be identified, and for shade detection of a current in each case, a sample with a 0.9 duty of may be identified.

Specifically, as shown in FIG. 4A, it can be seen that the array voltage V_{MPP} and the array current I_{MPP}, which are predicted at the MPP using the reference array voltage V_{array} and the reference array current array, are within a range of detecting Shade Pattern 1 which is uniform.

The V_{MPP} of Shade Pattern 1, which is uniform, may have an intensity of 76.82 V at a 1521-sample, and the I_{MPP} may have an intensity of 2.16 A at the 1581-sample. In “xxxx-sample,” the preceding four-digit number is a value indicating the order of samples. Hereinafter, a value indicating the order of samples and V_{MPP} or I_{MPP} may be expressed in the form of (X, Y).

In addition, it can be seen that Shade Pattern 5 and Shade Pattern 6 were detected in a third sample, from FIGS. 4B and 4C. In particular, it is noteworthy for Shade Pattern 5 and Shade Pattern 6 that the GPP case was successfully detected in a sample immediately following the third sample. In FIG. 4B, the V_{MPP} of Shade Pattern 5 is indicated as (1630, 86.54) and the I_{MPP} thereof is indicated as (1580, 1.917). In addition, in FIG. 4C, the V_{MPP} of Shade Pattern 6 is indicated as (1630, 86.54) and the I_{MPP} thereof is indicated as (1580, 1.917).

As described above, Equations 1 to 10 may be verified in the MPP operation of the PV array. In this way, since the knowledge of the GMPP is verified for all the shade patterns in the PV array, it can be seen that declaring a duty to track the MPP region in the shade detection is very efficient.

As described above, according to the present embodiment: first, shade detection is performed accurately on three samples; second, MPP tracking is possible within three samples in the case of the uniform shade and is possible within four samples in the case of the GPP; and third, for fast MPP convergence, a duty closer to the MPP region may be applied to the MPP tracking algorithm.

### GMPP Search in PS Case

Accurate identification of a GMPP in a very complex shade pattern is difficult as well as time consuming. Unlike a metaheuristic method, in order to avoid a high voltage switching transient phenomenon, the MPP tracking algorithm of the present embodiment may use a technique of using a large step size first and using a smaller step size later for duty declaration.

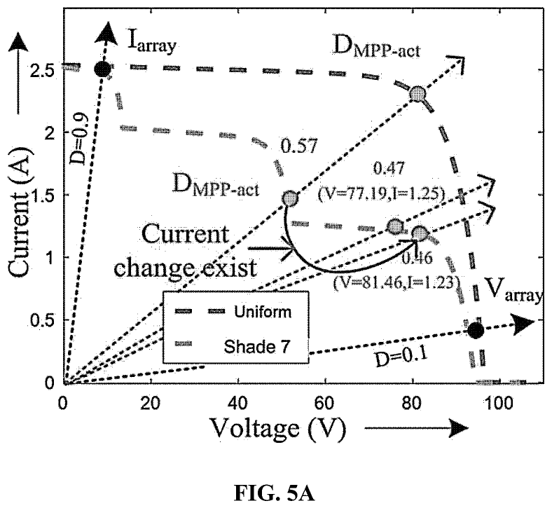

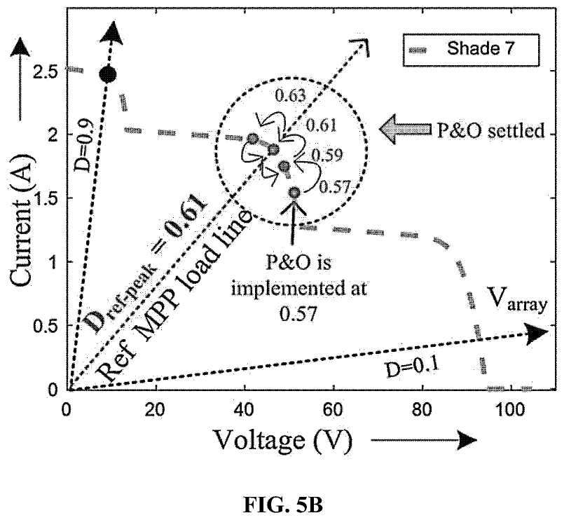

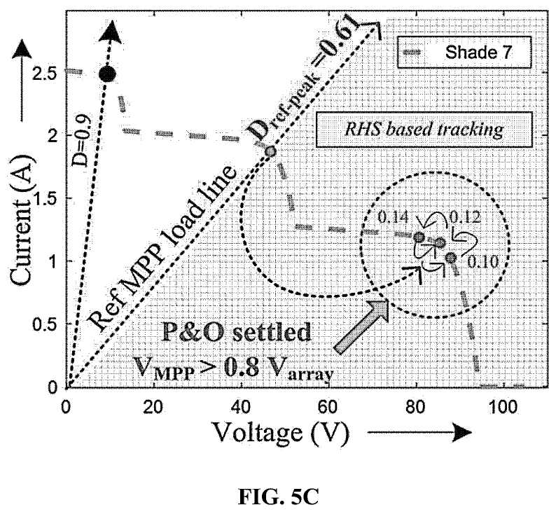

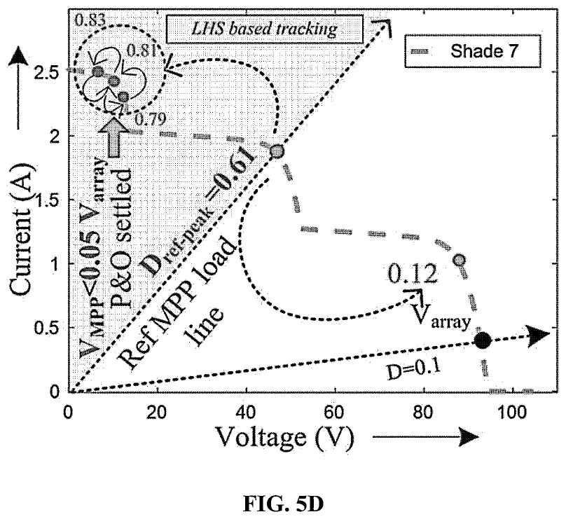

The MPP tracking algorithm of the present embodiment may be implemented in two steps, that is, exploration and exploitation, in the GMPP search process. This will be described with reference to FIGS. 5A to 5D.

FIG. 5A is a graph showing load line analysis results of Shade Pattern 1 and Shade Pattern 7. FIG. 5B is a graph for describing reference load line estimation of Shade Pattern 7. FIG. 5C is a graph for describing power peak estimation using a reference duty value in a right hand side (RHS) of a GMPP search. In addition, FIG. 5D is a graph for describing power peak estimation using a reference duty value in a left hand side (LHS) of the GMPP search.

In FIGS. 5A to 5D, Shade Pattern 1 or a uniform shade pattern is indicated as “Uniform,” and Shade Pattern 7 is indicated as “Shade 7.”

During a GMPP search process, the actual duty value D_{MPP-act} may be regarded as an initial reference duty value for finding an accurate GMPP region. Considering that there are several current changes in the I-V characteristics of the PS case, in a first step, that is, the exploration step, a current difference between samples which are declared as a relatively larger step size may be measured. In addition, when a significant difference is found, as a second step, that is, the exploitation step, an MPP tracking algorithm such as the P&O algorithm may be executed to investigate the probability of a power peak being present in the P-V characteristics.

As shown in FIGS. 5A to 5D, in order to describe the GMPP search process, P-V characteristics of Shade Pattern 1 and Shade Pattern 7 are described using parameters of the reference array voltage V_{array}, the reference array current I_{array}, and the actual duty value D_{MPP-act}.

In this case, a load line due to the actual duty value D_{MPP-act} may be indicated as the reference line. In addition, the GMPP search may be performed on both sides of the P-V characteristic using the actual duty value.

Duty declaration used for the GMPP search may be expressed as Equation 11, and a voltage limit for the GMPP search may be determined as in Equation 12.

$${D}_{ref} ( i + 1 ) = \{ \begin{matrix}{D}_{ref} ( i ) - Δ D for RHS , {D}_{v \_ max} = 0.1 \\ {D}_{ref} ( i ) + Δ D for LHS , {D}_{v \_ min} = 0.9\end{matrix} \qquad [ Equation 11 ]$$

$${V}_{max} = {V}_{0.1 - duty} {V}_{min} = {V}_{0.9 - duty} \qquad [ Equation 12 ]$$

In Equation 11, i is an iteration number, and ΔD is a step size of duty values and may have a value of 0.1.

When the duty value decreases during the GMPP search process, the detection and tracking apparatus may detect a significant current change as shown in FIG. 5A. Since a current difference according to the presence of such a current change is visualized in third and fourth samples of the MPP tracking algorithm, the current difference may be immediately retrieved through the MPP tracking algorithm such as the P&O method, and thus the controller of the PV panel may operate to stabilize a duty at a first immediate power peak.

In the present embodiment, as shown in FIGS. 5B to 5D, the stabilized duty may be indicated as “D_{ref-peak}” and referred to as a “stabilized duty.” Here, in order to find an exact MPP value, the MPP tracking algorithm may be declared with a 0.02 or 2% step size (see P&O settled).

In the GMPP search process, the current change may be expressed as Equation 13.

$$\vert {I}_{ref} ( i + 1 ) - {I}_{ref} ( i ) \vert > 10 \% {I}_{aray} \qquad [ Equation 13 ]$$

When Equation 13 is established, the duty may be changed into a relatively small step size. Otherwise, when Equation 13 is not established, the duty may be changed into a relatively large step size.

The above-described ratios for detecting current changes may only be obtained after performing many tests on various shade cases. In addition, for all given irradiation conditions, a measured current difference between the reference array current I_{array}, which is a short-circuit current at the second duty of the PV array, and the MPP array current I_{MPP} of the PV array was found to always exceed 10% of the reference array current. This confirms that all minor shade patterns each have a current difference that is greater than 10% of the reference array current I_{array}.

Therefore, in the embodiment, a reference duty “D_{ref-MPP}” may be determined as a new duty. In addition, in order to find the current difference, all the P-V characteristic curves may be scanned on both sides of the reference MPP load line at the reference duty.

When a significant current difference is found, a power peak can be identified using the MPP tracking algorithm. FIG. 5C shows an example in which the GMPP tracking is performed at the reference duty “D_{ref-MPP}” for the RHS of the P-V characteristic curve for identification of a power peak.

Then, as shown in FIG. 5D, after finding a power peak closer to the open circuit voltage V_{OC}, the GMPP search process may be restarted to find a power peak at the reference duty D_{ref-MPP} for the LHS region of the P-V characteristic curve.

Meanwhile, when a voltage of the retrieved power peak does not satisfy a voltage limit condition (see Equation 12), the detection and tracking apparatus stops the current exploration process using the MPP tracking algorithm and may re-declare the reference duty as the highest global GMPP duty in order to continuously perform the MPP tracking.

### Interpretation of Current Change in GMPP Tracking

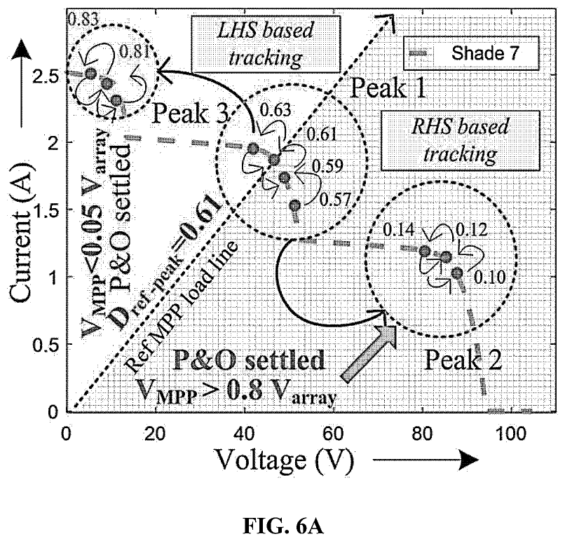

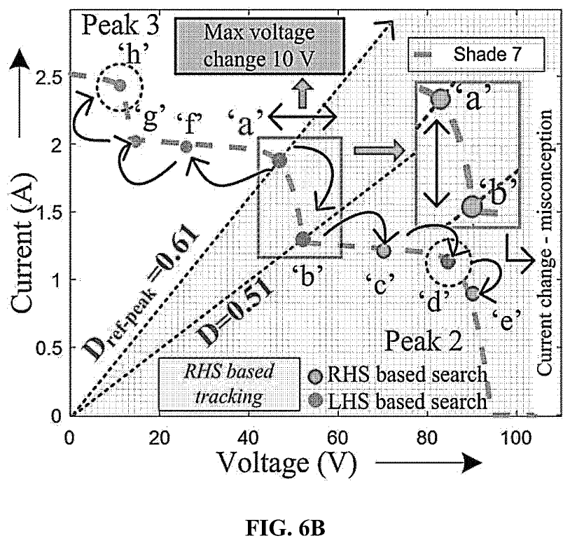

FIG. 6A is a graph for describing the GMPP tracking on Shade Pattern 7. In addition, FIG. 6B is a graph for describing a principle of RHS-based tracking which may be performed to solve a misconception about the current difference in Shade Pattern 7.

The MPP tracking algorithm, which may be employed in the detection and tracking method of the present embodiment, may be configured to start a search for a next peak toward the RHS of the P-V characteristic curve when one of the power peaks is retrieved.

Meanwhile, in a very complex shade case, there is a high possibility of showing a significant current change in a next sample due to the slope or step characteristic of the P-V characteristic curve. In other words, in a very complex shade case, confusion is caused in the GMPP tracking process so that a settled power peak may be repeatedly searched for due to a misconception about the current difference.

In order to describe this, the GMPP tracking process of the present embodiment considers Shade Pattern 7 which is a case having three power peaks as shown in FIG. 6A. In FIG. 6A, Shade Pattern 7 is indicated as Shade 7, and for better understanding, three power peaks Peak 1, Peak 2, Peak 3 on both sides of the I-V characteristic, and an RHS-based search and an LSH-based search of the GMPP tracking are explicitly shown.

In addition, in the GMPP tracking process of the present embodiment, a first power peak is identified as “D_{ref-peak}” as shown in FIG. 6B and settled close to shade detection named Point “a.” After settling to Point “a,” the duty value is perturbed to point “b” using Equation 11. In this case, a current change is accompanied by a negligible voltage drop.

This specific observation may be highlighted as in FIG. 6B. That is, when an erroneous search through the MPP tracking algorithm is triggered due to the above-described current change, the search for the same power peak may occur repeatedly. Therefore, in order to avoid a misconception about the current change, the detection and tracking method of the present embodiment may be configured to perform a search for a subsequent current change only when the current change exceeds a specific voltage range. The specific voltage range may be 0.5 V_{OC}. This may prevent the search from being repeatedly performed for the same power peak.

That is, when the search for the subsequent current change is performed only when the subsequent current change is greater than a threshold of a specific voltage, as shown in FIG. 6, a voltage difference up to 10 V may be obtained at a level of a predetermined voltage or more between a previous stabilized duty and a duty of a next sample. This shows that the voltage limiting method, which limits the subsequent current change to a specific voltage range, is effective for the GMPP search.

For example, FIG. 6B shows various points from “a” to “h” for distinguishing the RHS-based GMPP tracking process from the LHS-based GMPP search process. That is, in FIG. 6B, a shift from Point “a” to Point “e” (a, b, c, d, e) means the RHS-based search, and a shift from Point “a” to Point “h” (a, b, c, d, e) f, g, h) means the LHS-based search process.

A mathematical expression in which the MPP tracking algorithm settles to the power peak and then confirms a voltage limit of one module is the following Equation 14.

$$\vert {V}_{ref} ( i + 1 ) - {V}_{ref} ( i ) \vert > 0. 8 {V}_{m o d} \qquad [ Equation 14 ]$$

Here, “V_{ref}(i)” denotes an MPP value determined by the MPP tracking algorithm, “V_{ref}(i+1)” denotes a voltage of the next sample, and “V_{mod}” denotes a voltage of one module. A similar current misconception is likely to occur in the LHS search of the P-V characteristic curve. Therefore, Equation 14 may be used in the GMPP search toward the other side of the P-V characteristic curve.

### Convergence Analysis for Very Complex Shade Pattern

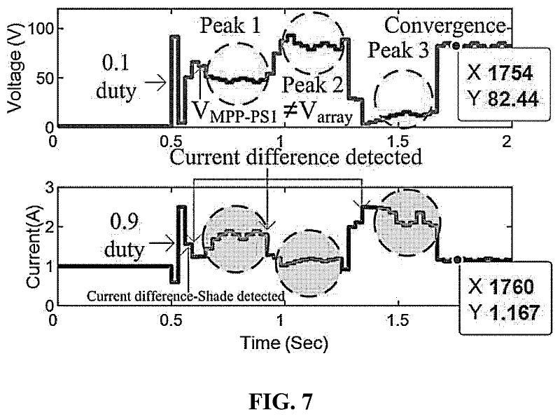

FIG. 7 is a graph for describing voltage and current convergence characteristics for Shade Pattern 7.

As shown in FIG. 7, the GMPP search based on the MPP tracking algorithm may be verified using MATLAB simulation for Shade Pattern 7, and the convergence of the GMPP search may be recorded. That is, shade detection may be confirmed in a fourth sample and a definite convergence characteristic of the shade detection may be visualized and shown through the GMPP search process. In addition, in order to observe the current difference, the GMPP search may be performed through the MPP tracking method and the search and exploitation processes may be performed using control variables. In addition, the fixation of voltage values and current values with respect to three various peaks may be clearly visualized.

The GMPP search of the present embodiment may be performed on the basis of voltage limitation and duty limitation as described above. In addition, in the P-V characteristic curve shown in FIG. 7, all the power peaks are identified through the MPP tracking algorithm, and then the GMPP may be clearly declared. As described above, the GMPP search of the present embodiment may accurately find the GMPP convergence characteristics for a very complex shade event.

Unlike the existing metaheuristic techniques, the detection and tracking method of the present embodiment has the following advantages. First, arbitrary duty declaration is not required. Second, very little parameter tuning may be performed. Third, information on all power peaks of a shade pattern may be obtained. Fourth, the complexity of the search algorithm is very low compared to the existing techniques.

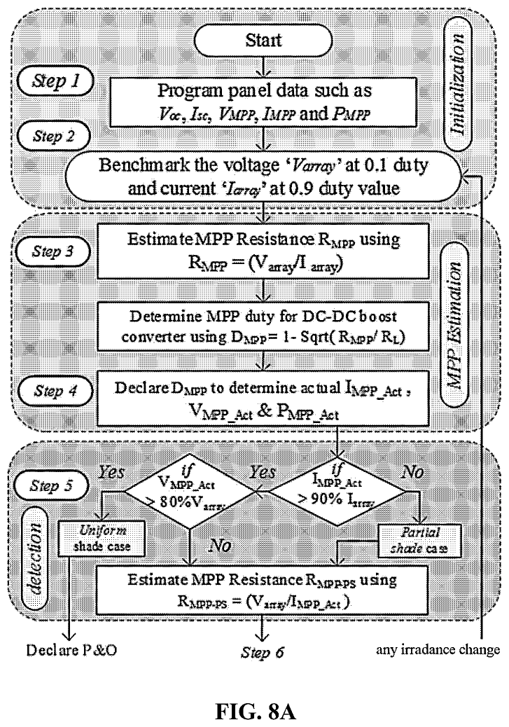

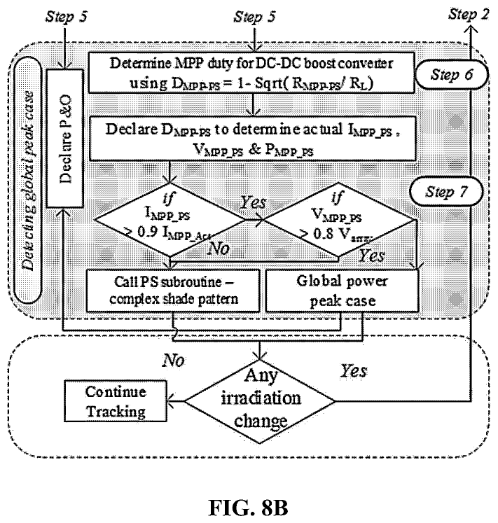

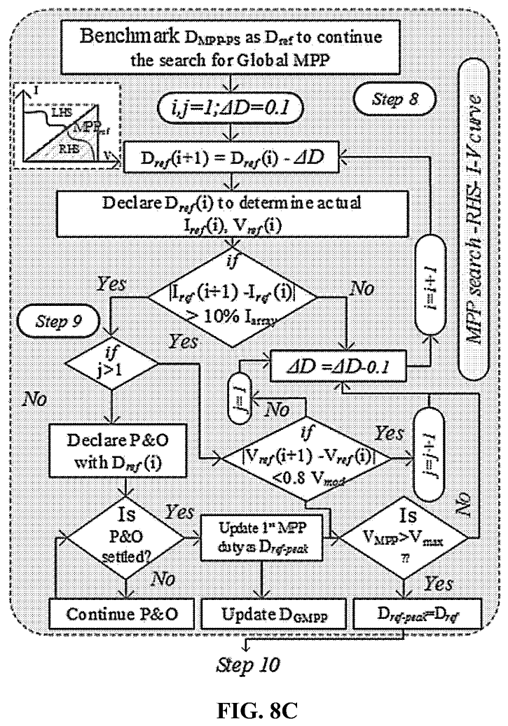

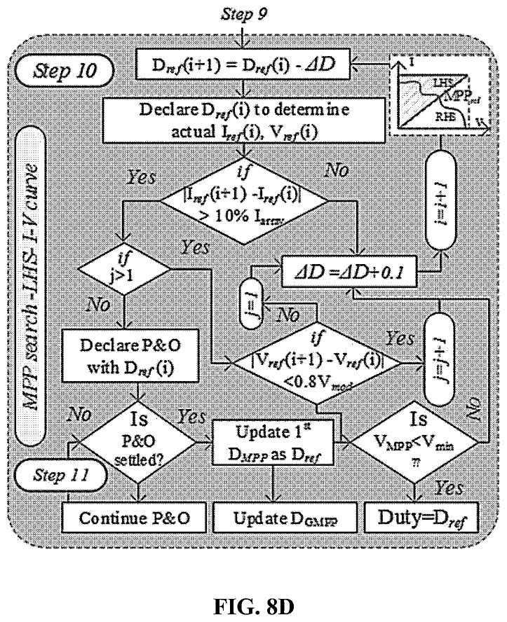

FIGS. 8A to 8D are flowcharts illustrating a novel shade detection and GMPP tracking method for efficient photovoltaic power conversion, that is, briefly referred to as a “detection and tracking method,” according to one embodiment of the present invention.

Referring to FIGS. 8A to 8D, step-by-step procedures for shade detection and GMPP operation for a very complex shade pattern are as follows.

Step 1: As an initial setting step, a data sheet value of the PV module is obtained under a standard test condition. That is, PV panel data including the open circuit voltage V_{OC} of the PV array, the short-circuit current I_{SC} of the PV array, the MPP current I_{MPP} of the PV array, the MPP voltage V_{MPP} of the PV array, and the MPP power P_{MPP} of the PV array may be programmed as the data sheet values.

Step 2: As a step of estimating the reference array voltage and the reference array current, a reference array voltage “V_{array}” at a 0.1 duty and a reference array current “I_{array}” at a 0.9 duty may be set (benchmarked).

A combination of the above-described step 1 and step 2 may be collectively referred to as an initialization step.

Step 3: As a step of determining an MPP duty, an MPP resistance R_{MPP} may be calculated and estimated using Equation 3, and an MPP duty value D_{MPP} may be calculated and determined using Equation 4 on the basis of the load resistance connected to the DC-DC converter.

Step 4: As a step of determining an actual MPP load line value, when the MPP duty value “D_{MPP}” is determined, an actual array voltage “V_{MPP-act}” and an actual array current “I_{MPP-act}” which are pieces of actual data may be determined on the basis of the determined MPP duty value “D_{MPP}.” That is, in step 4, the actual data set (I_{MPP-act}, V_{MPP-act}, and P_{MPP-act}) may be determined by declaring D_{MMP}.

A combination of the above-described step 3 and step 4 may be collectively referred to as an MPP estimation step.

Step 5: As a shade detection step or simply a detection step, in order to confirm the occurrence of a shade case using Equation 5 and Equation 6, the actual data set (V_{MPP-act}, I_{MPP-act}) at D_{MPP-act} may be compared with a reference data set (V_{array}, I_{array}) of the PV array.

As the comparison result, when a uniform shade profile is identified, the detection and tracking method may be configured to continuously perform the MPP tracking algorithm, and otherwise, to proceed to the following step 6 to detect a level depth indicating the severity of the shade case.

As one example, in step 5, when the actual array current is 90% or less of the reference array current, the detection and tracking method may determine as a PS case and estimate MPP resistance R_{MPP-PS} using Equation 7. On the other hand, when the actual array current exceeds 90% of the reference array current, the detection and tracking method may determine whether the actual array voltage exceeds 80% of the reference array voltage.

In addition, when the actual array voltage exceeds 80% of the reference array voltage, the detection and tracking method may determine a current shade case as a uniform shade case and declare, maintain, or perform GMPP tracking of the current shade case. The GMPP tracking may be performed through the existing P&O algorithm. In addition, when the actual array voltage is 80% or less of the reference array voltage, the detection and tracking method may estimate the MPP resistance R_{MPP-PS} using Equation 7.

Step 6: As a step of estimating a duty value in a less complex shade case, the MPP resistance is estimated in step 5, and then a duty D_{MPP-PS} at an RPP may be predicted using Equation 7 and Equation 8. That is, the MPP duty “D_{MPP-PS}” at the RPP of the DC-DC boost converter may be determined using Equation 8.

Step 7: As a step of identifying a very complex shade profile, in order to detect occurrence of a less complex shade case, the duty value “D_{MPP-PS}” is transmitted to a power electronics interface, and the actual data set (V_{MPP-PS}, I_{MPP-PS}) at the RPP may be detected. Then, when the less complex shade profile is diagnosed, the MPP tracking algorithm may be continuously performed, and otherwise, a GMPP subroutine may be executed to predict a GMPP region.

That is, the very complex shade case may be confirmed on the basis of the thresholds of Equation 9 and Equation 10. In other words, the duty value “D_{MPP-PS}” at the RPP may be declared, and an actual data set (V_{MPP-PS}, I_{MPP-PS}, P_{MPP-PS}) may be determined using the duty value “D_{MPP-PS}.”

Then, the detection and tracking apparatus may determine whether the actual array current I_{MPP-PS} at the RPP is greater than 0.9 times the actual array current I_{MPP-act} at the MPP and, when the actual array current I_{MPP-PS}, which is RPP current data, is greater than 0.9 times the actual array current I_{MPP-act} which is MPP current data, the detection and tracking apparatus may determine whether the actual voltage data V_{MPP-PS} at the RPP is greater than 0.8 times the reference array voltage V_{array}. When the actual voltage data V_{MPP-PS} is greater than 0.8 times V_{array}, the current shade case is determined as a global power peak case, and an MPP tracking algorithm such as the P&O algorithm may be newly declared on the basis of the global power peak case. In addition, when V_{MPP-PS} which is the RPP voltage data is less than or equal to 0.8 times the reference array voltage V_{array}, the current shade case may be determined as the global power peak case.

Meanwhile, when I_{MPP-PS}, which is the RPP current data, is less than or equal to 0.9 times I_{MPP-act} which is the MPP current data, a PS subroutine for detecting a complex shade pattern may be called.

A combination of the above-described step 6 and step 7 may be collectively referred to as the detecting of the global peak case. The global peak case may correspond to the global power peak case or the global power peak shade case.

In step 7, when the current shade case is determined as the global power peak case or the PS subroutine is called, in searching for any one among the uniform shade case, the global power peak shade case, and the PS case for the PV array, when corresponding irradiation changes within a predetermined time range at a specific point of time with respect to any irradiation given at the specific point of time, the detection and tracking method of the present embodiment may be configured to return to step 2 of a first part of the present process and repeat the present process. Meanwhile, when the irradiation does not change within a predetermined time range at the corresponding point of time, the MPP tracking process of FIGS. 8C and 8D may be continuously performed.

Step 8: As a step of starting a GMPP search, the GMPP search may be started using the actual duty value “D_{MPP-act}” as in Equation 4. That is, the GMPP search may be continuously performed by setting the duty value “D_{MPP-act}” of the third sample as the reference duty D_{ref}. Here, a step size ΔD between the duties may be set to 0.1. The MPP tracking algorithm may find the current difference using a large step size. As described above, the current difference may immediately settle to the first power peak. Accordingly, in the present embodiment, a duty of the first peak power is referred to as a reference peak duty “D_{ref-peak}.”

Step 9: As a GMPP search step for the RHS of the P-V characteristic, the MPP tracking algorithm with a “D_{ref-peak}” load line may be configured to search for the current difference for the RHS of the P-V characteristic using Equation 11. Detection of the current difference may be performed through Equation 13.

In step 9, when the current difference is diagnosed (if j=1), the MPP tracking algorithm may declare the current MPP tracking algorithm (e.g., P&O) on the basis of the diagnosed current difference D_{ref}(i). The present step may be configured to repeatedly perform the same process until V_{MPP} exceeds the actual array voltage Vₘₐₓ at a 0.1 duty in Equation 12.

In summary, when the current shade case is the PS case which is the very complex shade case, i and j may be set to 1 and the duty may be reduced from D_{ref}(i=1) to 0.1 (large step) up to the 0.1 duty which is D_{v_max}. That is, V_{MPP} at D_{ref} may be reduced to the reference array voltage V_{array}. Here, i and j indicate iteration numbers, and in particular, j indicates an iteration number which is set to prevent the same MPP from being searched for. That is, V_{MPP} at D_{ref} may be reduced to the reference array voltage V_{array}. Here, when the current differences before and after changing the duty do not satisfy a predetermined condition, that is, when Equation 13 does not hold, the GMPP may be searched for while continuously reducing the duty by 0.1. In addition, when Equation 13 is established, that is, when j is 1, the MPP may be found by reducing the step size by a predetermined size, for example, by 3% and applying the MPP tracking algorithm such as a P&O algorithm. In addition, when Equation 13 is satisfied, but j is not 1, it may be checked whether Equation 14 is satisfied in order to prevent the GMPP search from being confined to the same MPP.

A method of preventing the MPP search from being confined to the same MPP is as follows. First, by checking Equation 14, when a voltage difference between a previous sample and a next sample is less than 0.8 V_{mod} (a voltage of one PV module), J is made to be j=j+1 and, even when the current difference between the current sample and the next sample satisfies Equation 14, the step size is reduced so as not to proceed the process of finding the MPP so that the GMPP search confined to the same MPP may be avoided. It can be confirmed that the above process does not cause a misconception about the current difference when the maximum voltage change is 10 V, that is, the above process may proceed to a next MPP without being confined to one MPP (see FIG. 6B).

For the following GMPP search for the LHS, the same process as in the GMPP search for the RHS may be performed, excluding a case in which the GMPP search is performed until V_{MPP} is less than Vₘᵢₙ.

Step 10: As a GMPP search step for the LHS of the P-V characteristic, similar to step 9, the MPP tracking algorithm with the “D_{ref-peak}” load line may search for a current difference for the LHS of the P-V characteristic using Equation 11. A mathematical expression for detecting the current difference may be given as Equation 13.

In step 10, when the current difference is diagnosed (if j=1), the MPP tracking algorithm may declare the current MPP tracking algorithm (e.g., P&O) on the basis of the diagnosed current difference D_{ref}(i). The present step may be configured to repeatedly perform the same process until V_{MPP} is less than the actual array voltage Vₘᵢₙ at a 0.9 duty in Equation 12.

Step 11: As a step of finding a GMPP region, multiple power peaks are identified in the P-V characteristic, the duty value of the GMPP is identified, and then the DC-DC converter declares to continue a GMPP operation.

A combination of the above step 8 and step 9 may be collectively referred to as an MPP search-RHS-I-V curve step. In addition, a combination of the above step 10 and step 11 may be collectively referred to as an MPP search-RHS-I-V curve step.

### Performance Evaluation

In order to verify theoretical research results on the shade detection and the GMPP operation, research on simulation and hardware case studies was carried out. In particular, in the detection and tracking method according to the present embodiment, various uniform shade events and PS events were verified. For investigation, the shade patterns discussed in Table 1 are considered and important results of the shade detection are provided.

Simulation verification of the detection and tracking method according to the present embodiment may be performed in the MATLAB/SIMULINK environment as in FIG. 2. In addition, as in Table 1, the simulation verification may be based on the results of testing for the nine shade cases, that is, four uniform shade test cases, two less complex shade profiles, and the remaining three very complex shade profiles.

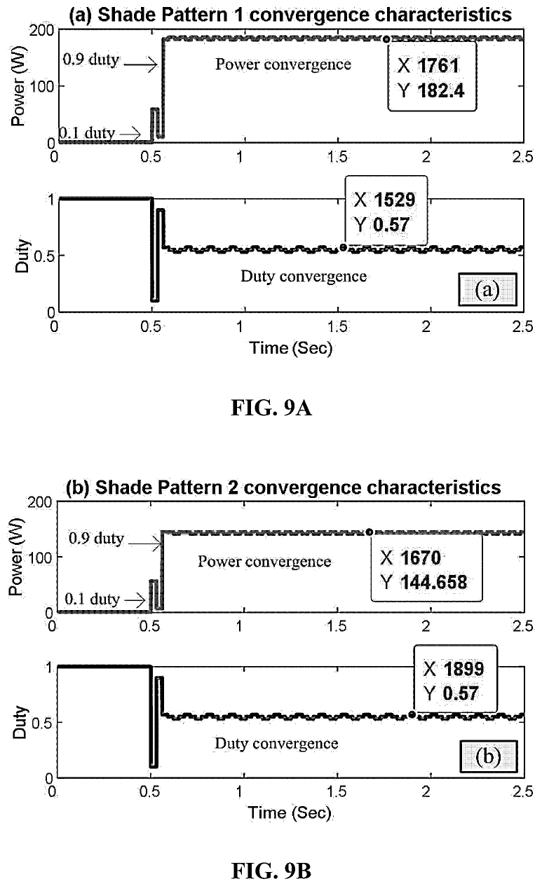

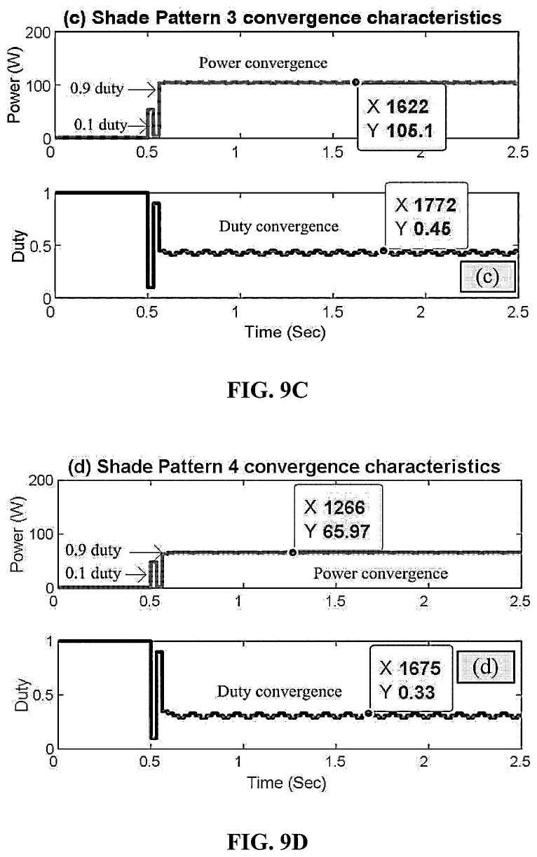

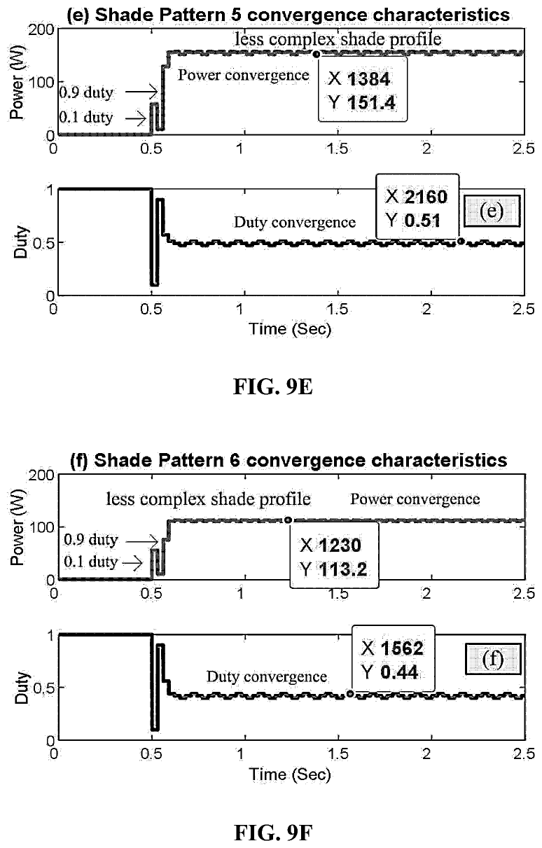

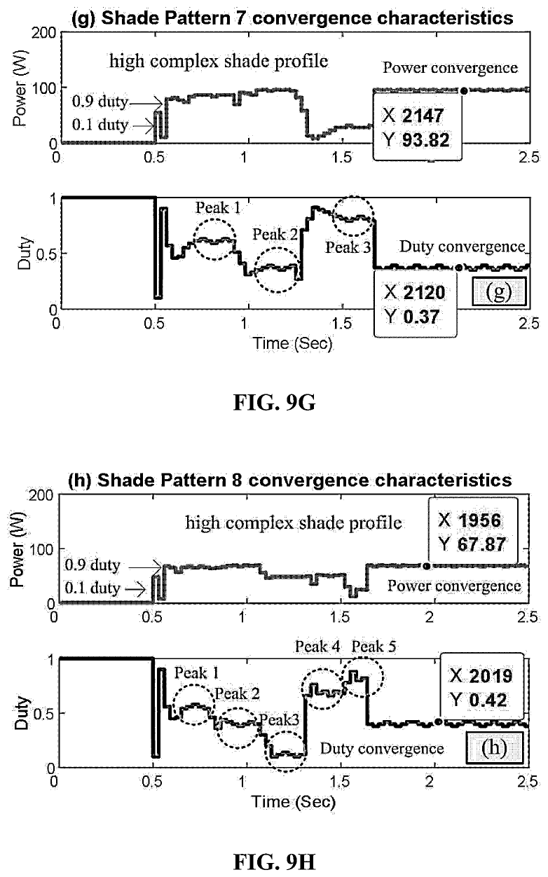

FIGS. 9A to 9I are graphs showing simulation verification results of Shade Patterns 1 to 9.

As shown in FIGS. 9A to 9D, since Shade Patterns 1 to 4 each have a uniform shade condition, duty convergence and power are immediately obtained in the third sample. Therefore, the P&O algorithm is declared closer to the MPP region. While confirming the P&O declaration, steady-state oscillations are found in the duty convergence and negligible power oscillations at the MPP are also recorded.

Next, as shown in FIGS. 9E and 9F, since Shade patterns 5 and 6 are less complex shade profiles, subsequent shade detection is diagnosed in the third sample. In addition, the current and voltage limits for the GPP case are confirmed in the fourth sample. The P&O algorithm is triggered immediately in the MPP region according to a result of the RPP shade event. In addition, power values of 151.4 W and 113.2 W are recorded for Shade Pattern 5 and Shade Pattern 6, respectively, so that the validity of the detection and tracking method of the present embodiment is verified.

Next, as shown in FIGS. 9G to 9I, Shade Patterns 7 to 9 each have the very complex shade pattern, and therefore, it can be seen that GMPP tracking for Shade Patterns 7 to 9 starts at the fourth sample. In order to verify the above, the duty convergence for all complex shade patterns is checked in a minimum 0.1 section and a maximum 0.9 section through a comprehensive search.

In addition, a local search of the P&O algorithm settling at various power peaks of Shade Pattern 7, Shade Pattern 8, and Shade Pattern 9 coincided with an actual number of power peaks of the shade profiles. This shows that the GMPP method of the present example exhibits successful performance.

In addition, a maximum convergence time required for the very complex shade profile is 1.2 seconds. This shows that the GMPP method of the present embodiment is the most competitive when compared to the existing GMPP methods.

The detection and tracking method of the present embodiment may be configured to obtain power peak information on the very complex shade profile and then to declare the P&O algorithm in the GMPP region.

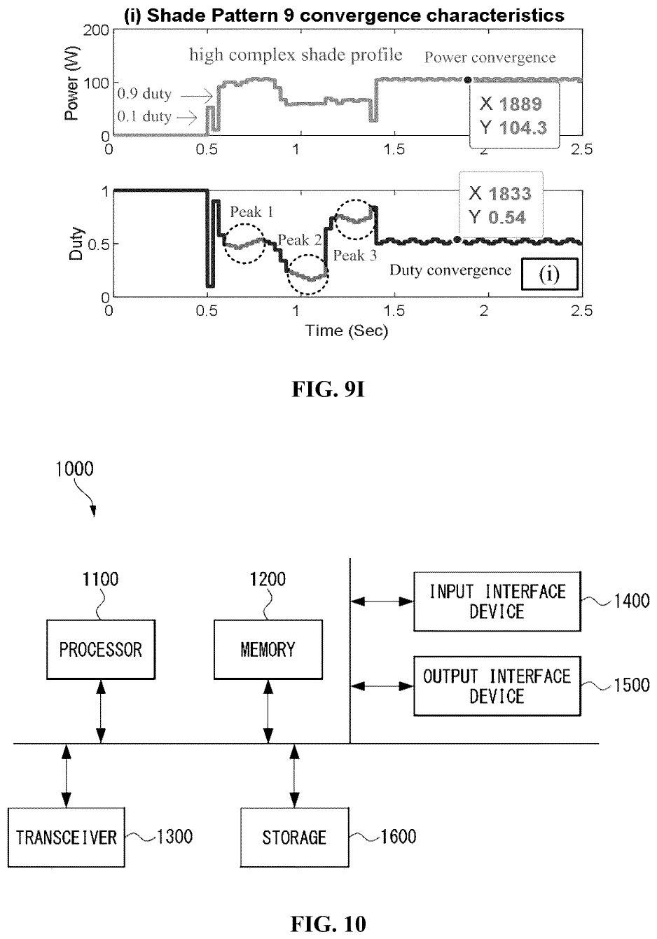

FIG. 10 is a schematic block diagram illustrating a novel shade detection and GMPP tracking apparatus (hereinafter briefly referred to as a “detection and tracking apparatus”) for efficient photovoltaic power conversion according to another embodiment of the present invention.

A test environment system for the detection and tracking method of the present embodiment may include a PV simulator, a DC-DC boost converter, a resistive load, a voltage sensor, and a current sensor.

Voltage sensor data and current sensor data are input to a controller of the test environment system, and the controller generates a control signal for a power electronics interface on the basis of the input data. For switch insulation, a driver circuit such as a half-bridge gate driver may be used. Other design parameters of the DC-DC boost converter may include a switching frequency of 10 kHz, an inductance of 1 mH, a capacitance of 100 μF at a voltage of 650 V, and a load resistance of 100Ω at a current of 15 A.

In addition, as shown in FIG. 10, the detection and tracking apparatus 1000 may include at least one processor 1100. In this case, at least one processor 1100 may be configured to process shade detection and MPP tracking.

In addition, the detection and tracking apparatus 1000 may selectively further include a memory 1200, a transceiver 1300, an input interface device 1400, an output interface device 1500, a storage 1600, or a combination thereof. The components included in the detection and tracking apparatus 1000 may be connected through a bus 1700 to communicate with each other.

The processor 1100 of the detection and tracking apparatus 1000 may execute a program command stored in at least one of the memory 1200 and the storage 1600. The program command may include commands for performing the procedure of the detection and tracking operation of FIGS. 8A to 8D. This program command may be implemented in the form of at least one software module. The above-described processor 1100 may be a central processing unit (CPU), a graphics processing unit (GPU), or a dedicated processor on which at least one method among the methods according to the embodiments of the present invention is performed.

Each of the memory 1200 and the storage 1600 may be formed of at least one of a volatile storage medium and a non-volatile storage medium. For example, the memory 1200 may be formed of at least one of a read only memory (ROM) and a random access memory (RAM).

The transceiver 1300 includes a part for supporting communication between a user terminal and a local server of other region through a wired, wireless, or satellite network, or a combination thereof or includes a component which performs a function corresponding to the device. The transceiver 1300 may include at least one sub-communication system for wired, wireless, satellite, or a combination thereof.

The input interface device 1400 may include input devices such as a keyboard, a microphone, a touch pad, a touch screen, and an input signal processing unit configured to map a signal input through at least one selected from among the input devices to a pre-stored command or process the signal, and transmit the signal to the processor 1100.

The output interface device 1500 may include an output signal processing unit configured to map or process a signal output under the control of the processor 1100 into a pre-stored signal form or level, and at least one output device configured to output a signal or information in the form of vibrations or light according to a signal from the output signal processing unit. The at least one output device may include at least one selected from among output devices such as a speaker, a display device, a printer, an optical output device, and a vibration output device.

The above-described detection and tracking apparatus 1000 may be used in the form of a personal computer functioning as a communication node, a web server, a computing server, an application server, a database server, a file server, a game server, a mail server, a proxy server, or a combination thereof. In addition, the above-described detection and tracking apparatus 1000 may be implemented with at least some functional units of a base station which is one node of a communication network, or a component configured to perform functions of the at least some functional units.

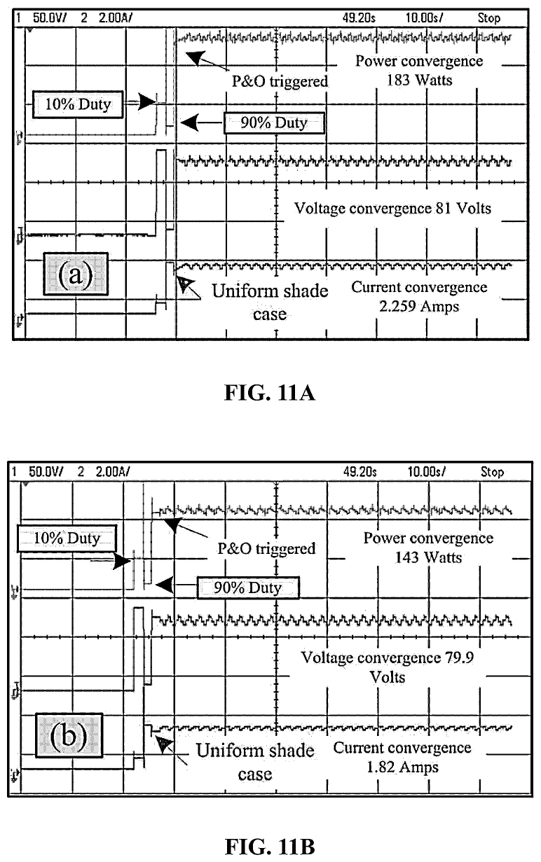

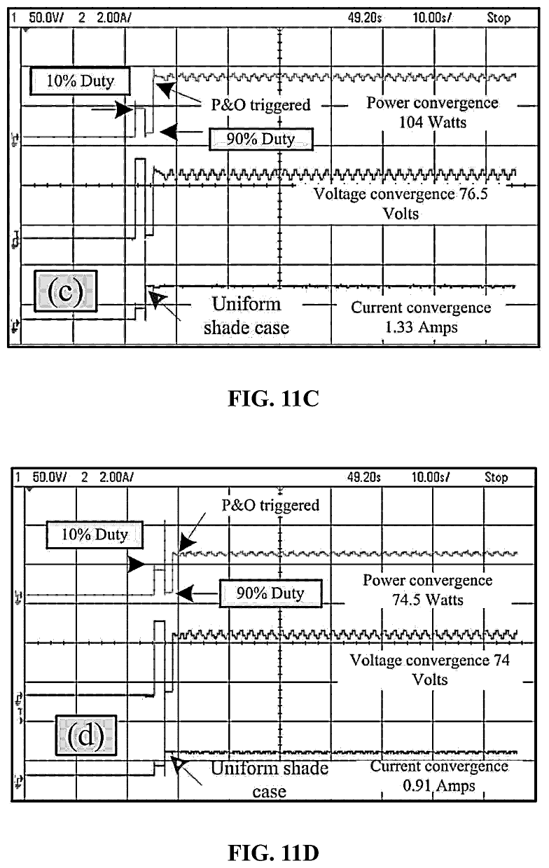

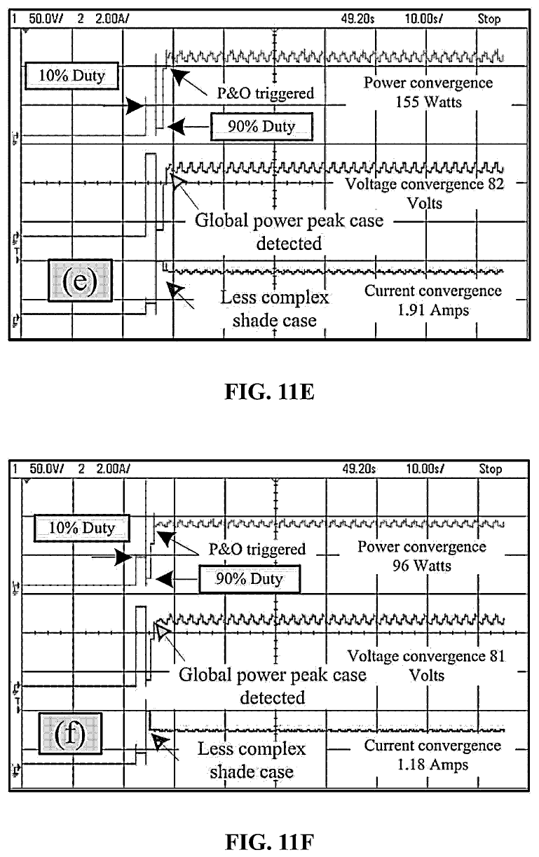

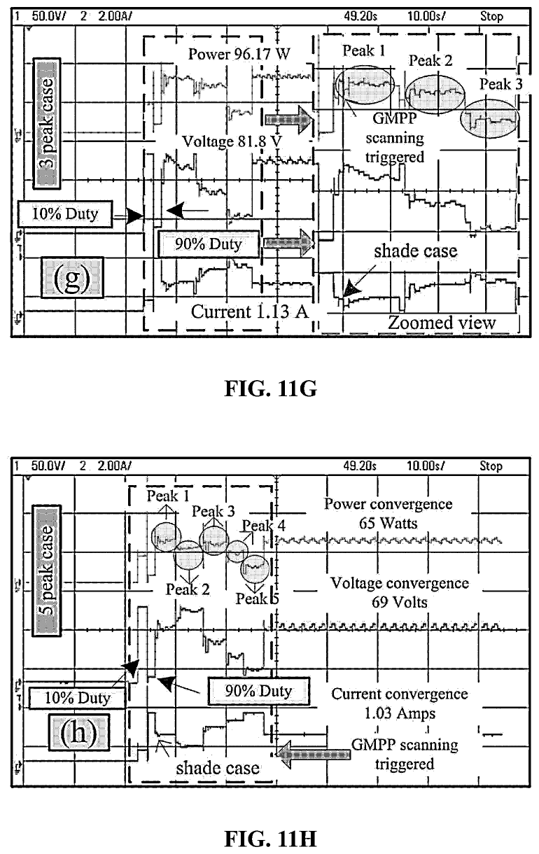

FIGS. 11A to 11I are graphs showing results according to hardware implementation of Shade Patterns 1 to 9, respectively.

First, referring to FIGS. 11A to 11D, similar to the simulation case study, it can be confirmed that Shade Patterns 1 to 4 were rapidly increased to diagnose the MPP position within three samples, and the P&O algorithm was declared closer to the MPP so that the detection and tracking method of the present embodiment achieved temporal convergence. That is, it can be confirmed that a formulated duty ratio that determines the array voltage “V_{array}” at the 0.1 duty and the array current “I_{array}” at the 0.9 duty from various voltages (74 V to 81 V) and currents (0.91 A to 2.259 A), which are set in the uniform shade cases, is correct.

In addition, as shown in FIGS. 11E and 11F, in the case of Shade Pattern 5 and Shade Pattern 6, a global power peak is detected in the fourth sample. Then, the P&O algorithm is initialized and its presence in the GMPP region is further secured. This confirms that the mathematical evaluation formulated in Equation 9 and Equation 10 is valid in real time. That is, by recognizing the GMPP region, it can be confirmed that an instantaneous power convergence of each of 155 W and 96 W was recorded as shown in FIGS. 11E and 11F.

In addition, as shown in FIGS. 11G to 11I, the GMPP search was performed for Shade Patterns 7 to 9 by recognizing complex shade detection in the fourth sample. In addition, the detection of the power peaks on the basis of the current difference is very advantageous in achieving an accurate GMPP. In particular, as shown in FIG. 11H, five power peaks for Shade Pattern 8 show characteristics of a contaminated solar system which is adversely affected by the environment.

The GMPP tracking method of the present embodiment achieved a power convergence of about 65 W (69 V, 0.9 A) so that potential of the GMPP tracking method was confirmed. In addition, for understanding in the GMPP-based search of the present embodiment, hardware implementation of Shade Pattern 7 is shown in detail in FIG. 11F. In addition, as in the case of Shade Pattern 8, GMPP regions were accurately diagnosed for Shade Pattern 7 and Shade Pattern 9, and a power convergence of each of 96 W and 106 W was achieved.

### Comparison with PSO Algorithm of Comparative Example

In order to verify the shade detection technique of the detection and tracking method according to the present embodiment, a comparative study was conducted on the hardware implementation of the present embodiment, a PSO algorithm of the comparative example, and a hybrid rolling average test (RAT) algorithm. Test patterns of the uniform shade event (Case 1), the global power peak event (Case 5), and the complex shade event (Case 7) were evaluated in a real test environment.

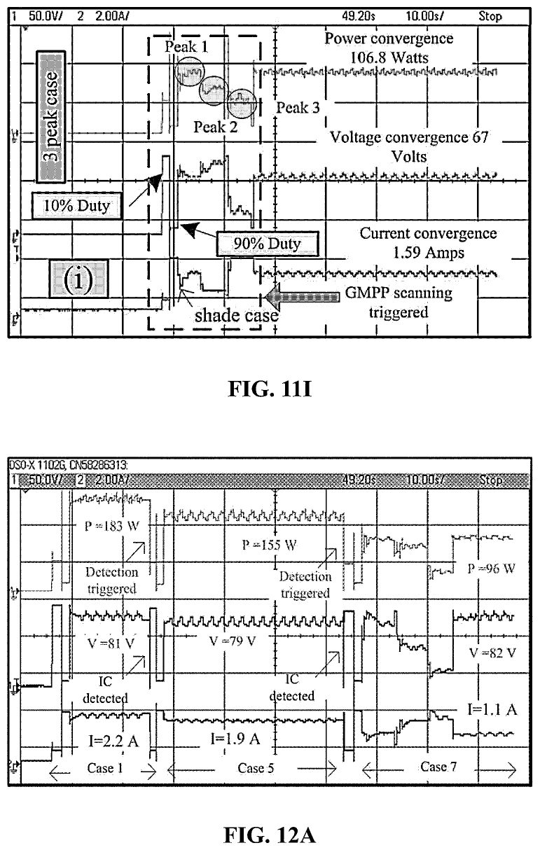

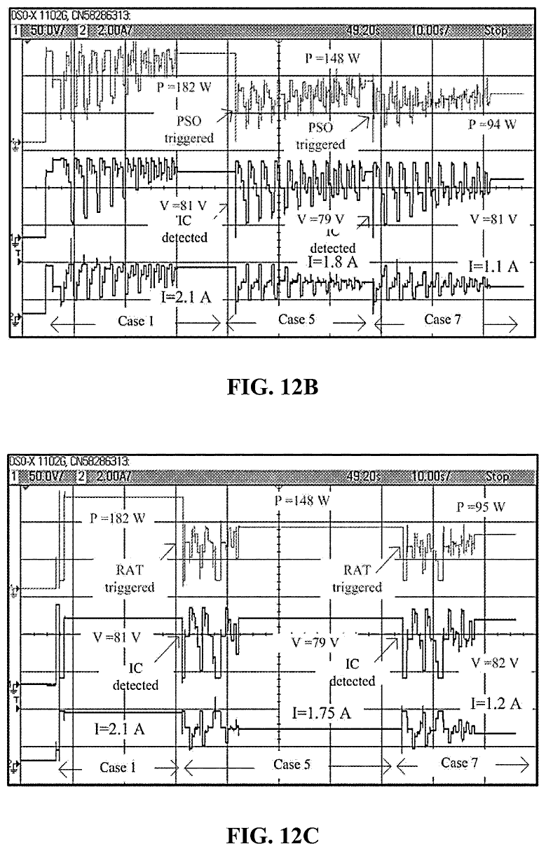

FIG. 12A is a graph showing the results of applying the detection and tracking method of the present embodiment to the PV system. FIG. 12B is a graph showing the results of applying the PSO method of the comparative example to the PV system. In addition, FIG. 12C is a graph showing the results of applying the hybrid RAT algorithm of another comparative example to the PV system.

FIGS. 12A to 12C show case study results obtained from hardware implementation, and all three methods show comprehensive durability for the power peaks.

Various parameters that need to be evaluated in the MPP operation of the PV system include (i) convergence time, (ii) shade detection, (iii) power oscillation, (iv) algorithm complexity, (v) parameter tuning, and (vi) LMPP discrimination. When the performance of the shade detection technique of the present embodiment is evaluated together with the PSO algorithm of the comparative example and the hybrid RAT algorithm of the other comparative example, the following observations may be made.
(i) In the shade detection, an operation of finding an MPP is essential to distinguish a uniformly irradiated case from other shade events. In metaheuristic-based GMPP finding methods such as PSO and hybrid detection methods, shade detection is difficult because high switching transients occur during MPP convergence.
(ii) Although shade detection is implemented in the hybrid RAT algorithm, the shade detection is preferably used for all shade events. However, the performance of the hybrid RAT algorithm is uncertain under time-varying temperature conditions.
(iii) The proposed algorithms achieve power convergence using a small number of samples, whereas the PSO algorithm consumes more samples due to high voltage fluctuations.
(iv) Parameter tuning and algorithm complexity are dependent parameters. The proposed method requires only one parameter for tuning. However, since the hybrid RAT and PSO methods require four and five parameters, respectively, more computational ability is required.
(v) The PSO and RAT methods converged to the GMPP for all three shade events, but the information on the number of power peaks and corresponding power values of the P-V characteristics is not accurate.
(vi) In addition, random initialization of the duty values in the PSO and RAT methods is a fundamental cause of always converging to the LMPP. Conversely, the algorithm of the present embodiment has information on all the power peaks in order to accurately determine the LMPP.

According to the above-described embodiment, it is possible to provide a novel shade detection method of discriminating a uniformly irradiated shade event, a less complex shade event, and a very complex shade event. Furthermore, the GMPP regions for all types of shade phenomena can be accurately diagnosed only with a simplified P&O method. In addition, the P&O algorithm implemented closer to the GMPP region with a maximum of four samples for a complex shade pattern can be used as a useful solution for real-time MPPT.

In addition, the detection and tracking method of the present embodiment was verified for nine different shade patterns of a 5×1 array, and it was confirmed that real-time hardware was implemented to exhibit excellent performance compared to the PSO algorithm and the hybrid RAT algorithm of the comparative example. In addition, key parameters for real-time implementation of the detection and tracking method of the present embodiment are fast convergence, high power conversion efficiency, and information on various power peak positions, and the shade detection and GMPP tracking method of the present embodiment using the key parameters can have the following advantages: first, calculation is easy; second, the method is reliable; third, the method is less complicated; and fourth, the method is very powerful.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A shade detection and global maximum power point (GMPP) tracking method, which is performed by a processor, comprising:
setting an array voltage at a 0.1 duty and an array current at a 0.9 duty among data sheet values of a photovoltaic (PV) array of a PV module as a reference array voltage and a reference array current, respectively;
calculating a maximum power point (MPP) resistance of the PV array on the basis of the reference array voltage and the reference array current;
calculating a duty to be applied to a switch of a boost converter of the PV module on the basis of the MPP resistance;
obtaining an actual array voltage and an actual array current of the PV array on the basis of the duty; and
determining whether a uniform shade case occurs on the basis of the actual array voltage, the actual array current, and actual power obtained from the actual array voltage and the actual array current,
wherein, the determining of whether the uniform shade case occurs includes determining whether the actual array current is greater than or equal to 0.9 times the reference array current.

2. The shade detection and GMPP tracking method of claim 1, further comprising,
after the determining of whether the uniform shade case occurs,
detecting a shade level for severity of a current shade case,
wherein the shade level includes a global power peak case which is a relatively less complex shade case, and a partial shade case which is a relatively more complex shade case.

3. The shade detection and GMPP tracking method of claim 2, further comprising determining that the global power peak case occurs when a change of a preset reference value or more in each of the actual array voltage and the actual array current occurs on the basis of the duty.

4. The shade detection and GMPP tracking method of claim 3, further comprising determining that the partial shade case occurs when each of the actual array voltage and the actual array current does not satisfy the preset reference value.

5. The shade detection and GMPP tracking method of claim 4, further comprising searching for a GMPP when it is determined that the partial shade case occurs,
wherein the searching for the GMPP uses a relatively large step size first and then uses a relatively small step size when changing the duty in MPP tracking.

6. The shade detection and GMPP tracking method of claim 5, wherein the searching for the GMPP in the PS case includes:
performing a search by continuously using the large step size when a current difference between actual array currents according to a change in duty is 10% or less of the reference array current; and
changing to a preset small step size and performing a search again when the current difference exceeds 10% of the reference array current.

7. The shade detection and GMPP tracking method of claim 1, further comprising setting the duty to be closest to the MPP located on a voltage-current curve when the current shade case is the uniform shade case.

8. The shade detection and GMPP tracking method of claim 1, further comprising, after the determining of whether the uniform shade case occurs, detecting a shade level for severity of the current shade case,
wherein the detecting of the shade level includes determining that the current shade case is the uniform shade case when the actual array voltage exceeds 80% of the PV array voltage.

9. The shade detection and GMPP tracking method of claim 8, further comprising searching for a GMPP using the MPP resistance.

10. The shade detection and GMPP tracking method of claim 9, further comprising:
setting a step size of the duty to a predetermined value in the searching for the GMPP; and
declaring a step size that is greater than the predetermined value in order to find a current difference.

11. The shade detection and GMPP tracking method of claim 10, further comprising, after the declaring of the step size, diagnosing the current difference using a duty of first peak power as a reference duty.

12. The shade detection and GMPP tracking method of claim 11, wherein the diagnosing of the current difference includes determining whether the actual array voltage exceeds a limit of the PV array voltage.

13. The shade detection and GMPP tracking method of claim 12, further comprising performing a GMPP search for at least one of a right hand side (RHS) and a left hand side (LHS) of a reference MPP load line when the actual array voltage exceeds the limit of the PV array voltage.

14. A shade detection and global maximum power point (GMPP) tracking apparatus, comprising:
a processor configured to execute at least one program command stored in a memory or a storage,
wherein, in response to the at least one program command, the processor performs:
setting an array voltage at a 0.1 duty and an array current at a 0.9 duty among data sheet values of a photovoltaic (PV) array of a PV module as a reference array voltage and a reference array current, respectively;
calculating a maximum power point (MPP) resistance of the PV array on the basis of the reference array voltage and the reference array current;
calculating a duty to be applied to a switch of a boost converter of the PV module on the basis of the MPP resistance;
obtaining an actual array voltage and an actual array current of the PV array on the basis of the duty; and
determining whether a uniform shade case occurs on the basis of the actual array voltage, the actual array current, and actual power obtained from the actual array voltage and the actual array current,
wherein in the determining of whether the uniform shade case occurs, the processor determines whether an intensity of the actual array current is greater than or equal to 0.9 times an intensity of the reference array current.

15. The shade detection and GMPP tracking apparatus of claim 14, wherein the processor:
receives a PV array current from a current sensor configured to detect a current flowing through a positive terminal of two terminals of a boost converter connected to the PV array;
receives a PV array voltage from a voltage sensor configured to detect a voltage between both ends of a first capacitor connected parallel to the two terminals of the boost converter connected to the PV array; and
controls operation of a switch for MPP tracking in the boost converter on the basis of the PV array current and the PV array voltage.

16. The shade detection and GMPP tracking apparatus of claim 15, wherein, after the determining of whether the uniform shade case occurs, the processor further performs detecting a shade level for severity of the current shade case,
wherein the shade level includes a global power peak case which is a relatively less complex shade case, and a partial shade case which is a relatively more complex shade case.

17. The shade detection and GMPP tracking apparatus of claim 16, wherein the processor further performs determining that the global power peak case occurs when a change of a preset reference value or more in each of the actual array voltage and the actual array current occurs on the basis of the duty.

18. The shade detection and GMPP tracking apparatus of claim 17, wherein the processor further performs determining that the partial shade case occurs when each of the actual array voltage and the actual array current does not satisfy the preset reference value.

19. The shade detection and GMPP tracking apparatus of claim 18, wherein:
the processor further performs searching for a GMPP when it is determined that the partial shade case occurs; and
in the searching for the GMPP, the processor uses a relatively large step size first and then uses a relatively small step size when changing the duty value in MPP tracking.

20. The shade detection and GMPP tracking apparatus of claim 19, wherein, in the searching for the GMPP, the processor performs a search by continuously using the large step size when a current difference between actual array currents according to a change in duty is 10% or less of the reference array current, and changes to a preset small step size and performs a search again when the current difference exceeds 10% of the reference array current.
